(19) United States
(12) Patent Application Publication
(10) Pub. No.: US 2025/0294543 A1
(43) Pub. Date: Sep. 18, 2025

(54) TIMELINE DETERMINATION OF TRANSMITTER SWITCHING

(71) Applicant: ZTE Corporation, Shenzhen (CN)

(72) Inventors: Jing SHI, Shenzhen (CN); Xianghui HAN, Shenzhen (CN); Xingguang WEI, Shenzhen (CN); Shuaihua KOU, Shenzhen (CN)

(21) Appl. No.: 19/223,460

(22) Filed: May 30, 2025

Related U.S. Application Data
(63) Continuation of application No. PCT/CN2023/076290, filed on Feb. 15, 2023.

(51) Int. Cl. H04W 72/0453

(52) U.S. Cl. CPC H04W 72/0453

(57) ABSTRACT

Wireless communications with uplink transmitter (Tx) switching may include an optional user equipment (UE) capability that allows uplink (UL) transmission on a band with the number of Tx chains unchanged during the switching. One Tx chain may be maintained on the band during UL switching. The optional UE capability may include modifications to the switching timeline. For example, an UL transmission on a third band may be made during UL Tx switching between two other bands.

### CROSS-REFERENCE TO RELATED APPLICATION

This application is a continuation and claims priority to International Application No. PCT/CN2023/076290, filed on Feb. 15, 2023, the disclosure of which is hereby incorporated by reference herein in its entirety.

### TECHNICAL FIELD

This document is directed generally to wireless communications. More specifically, in a mobile device communications system, there may be improved communications for uplink transmitter switching.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for uplink transmitter switching in wireless communications. An optional user equipment (UE) capability may allow uplink (UL) transmission on a band with the number of transmitter (Tx) chains unchanged during the switching. One Tx chain may be maintained on the band during UL switching. The optional UE capability may include modifications to the switching timeline. For example, an UL transmission on a third band may be made during UL Tx switching between two other bands.

In one embodiment, a method for wireless communication includes a method for wireless communication, performed by a wireless communication device, comprising: receiving an indication of triggering of an uplink (UL) transmitter (Tx) switching between two bands; and transmitting an UL transmission on a third band during the UL Tx switching. The method includes transmitting an indication of triggering of an uplink (UL) transmitter (Tx) switching between two bands; and triggering an UL transmission on a third band during the UL Tx switching. The two bands comprise a first band and a second band, further wherein the switching is from the first band to the second band. The indication comprises a first Downlink Control Information (DCI) and the UL transmission on the third band during the UL Tx switching is triggered by a second DCI. The second DCI for triggering the UL transmission on the third band is received before a gap ahead of a start of the UL transmission on the second band after the UL Tx switching. The second DCI for triggering the UL transmission on the third band is received after a gap ahead of the start of the UL transmission on the second band. The second DCI for triggering the UL transmission on the third band is before a gap of ahead of the start of UL transmission on the third band. The first DCI for triggering the UL transmission on the second band is received before a gap ahead of a start of the UL transmission on the third band.

In another embodiment, a method for wireless communication includes method of wireless communication, performed by a wireless communication device, comprising: receiving a trigger for two uplink (UL) transmission (Tx) chains to switch between two different band pairs; and identifying a 1-port transmission on one band and a 1-port transmission on another band after the switching as a single Tx switching based on a restriction. The restriction comprises the two UL transmissions after the Tx switching is partial overlapped or a gap of the two UL transmissions is less than a threshold value. The gap of the two UL transmissions is less than the threshold value and the two UL transmissions are within different slots. The threshold value is a switching gap of the UL Tx switching. The restriction comprises the two UL transmissions after the Tx switching are within a reference slot.

In another embodiment, a method for wireless communication includes a method of wireless communication, performed by a wireless communication device, comprising: transmitting up to two uplink (UL) transmissions on a subset of bands from a band combination after a UL transmitter (Tx) switching; and establishing a condition for the transmitting, wherein 3Tx are supported by the wireless communication device. One of the UL transmissions comprises a 1-port, 2-port, or 3-port transmission on one UL carrier on one band of the band combination. When the 2-port transmission on a UL carrier is on one band after UL Tx switching and when a preceding UL transmission with a 3Tx state is on another band, then the Tx state after the UL Tx switching is 2Tx or 3Tx on one band by a parameter with two candidate values. When the 1-port transmission on a UL carrier on one band after UL Tx switching and when a preceding UL transmission with 3Tx state on another band, then the Tx state after the UL Tx switching is 1Tx, 2Tx or 3Tx on one band by a parameter with three candidate values.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a block diagram of an example configuration of a transceiver and

antenna.

FIG. 4 shows a block diagram illustrating relationships between carriers, bands, and cells.

FIG. 5a shows an embodiment of a User Equipment (UE) baseline assumption.

FIG. 5b shows an embodiment of a User Equipment (UE) optional capability.

FIG. 6 shows an example uplink (UL) transmission on band C overlapped with a gap of switching.

FIG. 7 shows another example uplink (UL) transmission on band C overlapped with a gap of switching.

FIG. 8a shows an embodiment of a User Equipment (UE) baseline assumption with simultaneous transmission.

FIG. 8b shows an embodiment of a User Equipment (UE) optional capability with simultaneous transmission.

FIG. 9 shows an example uplink (UL) transmission on band C overlapped with a gap of switching with simultaneous transmission.

FIG. 10 shows an embodiment with four bands.

FIG. 11 shows an example uplink (UL) transmission on four bands with a gap of switching.

FIG. 12 shows another example uplink (UL) transmission on four bands with a gap of switching.

FIG. 13 shows a first example transmission timeframe on four bands with a gap of switching.

FIG. 14 shows a second example transmission timeframe on four bands with a gap of switching.

FIG. 15 shows a third example transmission timeframe on four bands with a gap of switching.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Based on the current development trend, 4G and 5G systems are developing supports on features of enhanced mobile broadband (eMBB), ultra-reliable low-latency communication (URLLC), and massive machine-type communication (mMTC). Full duplex may be a requirement for 5G and subsequent communication systems. In wireless communication, a network device, such as a user equipment (UE), may perform uplink (UL) transmitter (Tx) switching within up to two bands. For multi-carrier operation, a network device that transmits with two transmitters (also called a 2Tx user device), may transmit in two UL bands. Which two bands that are used may only be changed by radio resource control (RRC) reconfiguration. A 2Tx user device may perform UL Tx switching between two UL bands. UL Tx switching schemes may not allow a user device to perform UL Tx switching with three or more bands and simultaneous transmission with two transmitters, to enable more configured UL bands than its simultaneous transmission capability, and/or to support dynamic Tx carrier switching across configured bands. Dynamically selecting carriers with UL Tx switching (e.g., based on the data traffic, TDD downlink (DL)/uplink (UL) configuration, bandwidths and channel conditions of each band, instead of RRC-based cell(s) reconfiguration), may potentially lead to higher UL data rate, spectrum utilization and UL capacity. UL Tx switching schemes across up to three, four, or more bands with restriction of up to 2 Tx simultaneous transmission for FR1 UEs (including mechanisms to enable more configured UL bands than its simultaneous transmission capability and to support dynamic Tx carrier switching across the configured bands) may not be fully supported without the embodiments described below.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

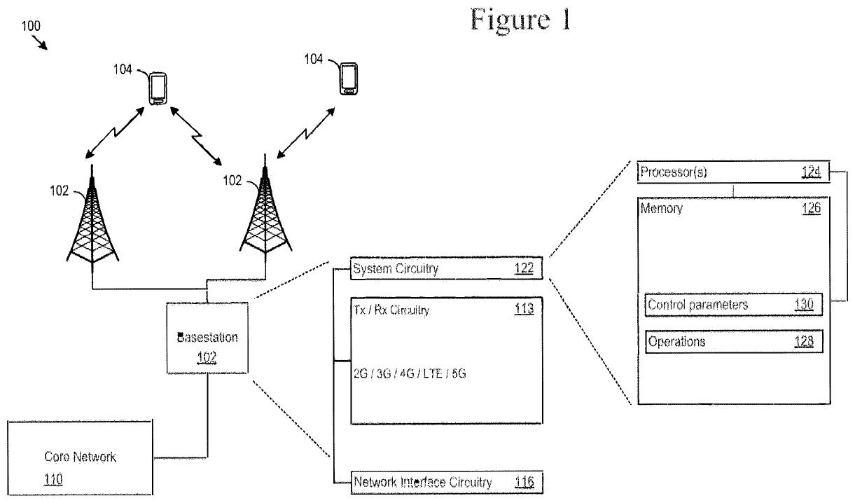

FIG. 1 shows an example basestation 102. The basestation may also be referred to as a network device or wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals. Also, particular signals can be characterized or defined as either an uplink (UL) signal, a downlink (DL) signal, or a sidelink (SL) signal. An uplink signal is a signal transmitted from a UE 104 to a basestation 102. A downlink signal is a signal transmitted from a basestation 102 to a UE 104. A sidelink signal is a signal transmitted from one UE 104 to another UE 104.

For at least some specifications, such as 5G New Radio (NR), data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a basestation 102 to a UE 104. In other embodiments, the control information includes uplink control information (UCI) that is transmitted in the uplink direction from a UE 104 to a basestation 102, or sidelink control information (SCI) that is transmitted in the sidelink direction from one UE 104 to another UE 104.

In addition, in some embodiments, a UE 104 may be configured to support at least one simultaneous UL transmission mode across a band pair for UL transmissions. In a first simultaneous UL transmission mode (also called a switchedUL mode), the UE 104 does not support simultaneous UL transmission across a band pair. Accordingly, when the UE 104 transmits an UL transmission in the first simultaneous UL transmission mode, the UE 104 transmits the UL transmission without simultaneously transmitting across a band pair. In addition, in a second simultaneous UL transmission mode (also called a dualUL mode), the UE 104 supports simultaneous UL transmission across a band pair. Accordingly, when the UE 104 transmits an UL transmission in the second simultaneous UL transmission mode, the UE 104 may transmit the UL transmission by simultaneously transmitting across a band pair.

Also, in some embodiments, the UE 104 may report the simultaneous UL transmission mode(s) to the basestation 102. That is, the UE 104 may report, to the basestation 102, that it supports simultaneous UL transmission across a band pair, that it does not support simultaneous UL transmission across a band pair, or that it both supports and does not support simultaneous UL transmission across a band pair. In particular of these embodiments, the UE 104 may report whether or not it supports simultaneous UL transmission across a band pair per band combination (BC). Also, the basestation 102 may configured the simultaneous UL transmission mode (e.g., switchedUL or dualUL) per cell group, which may be considered as per BC or per band pair in embodiments where a 2Tx user device supports only two bands. That is, one available band pair in a band combination may support one simultaneous UL transmission mode.

Additionally, in general as used herein, a band combination may include a plurality of bands (e.g., five bands). In addition, as used herein, a band group may include up to three or four bands. A given band group may be included in or part of a band combination. Also, a band combination and/or a band group may include at least one band pair, where a band pair includes two bands.

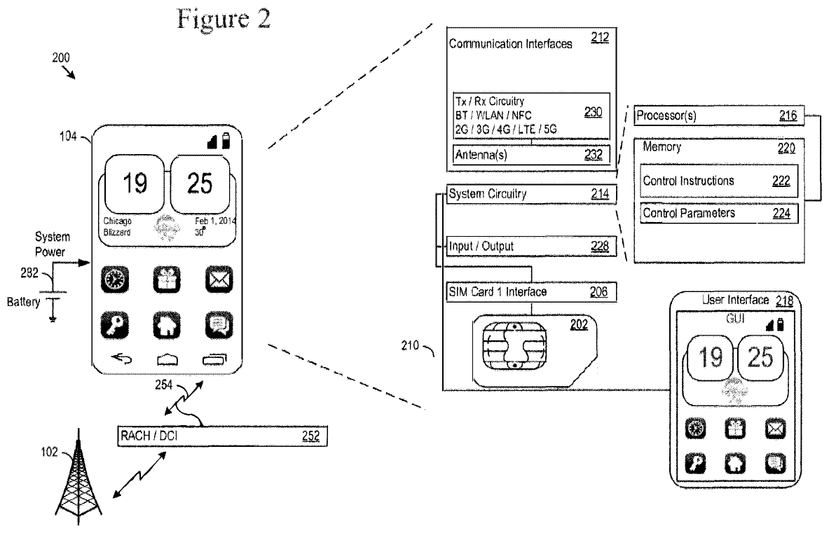

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC.

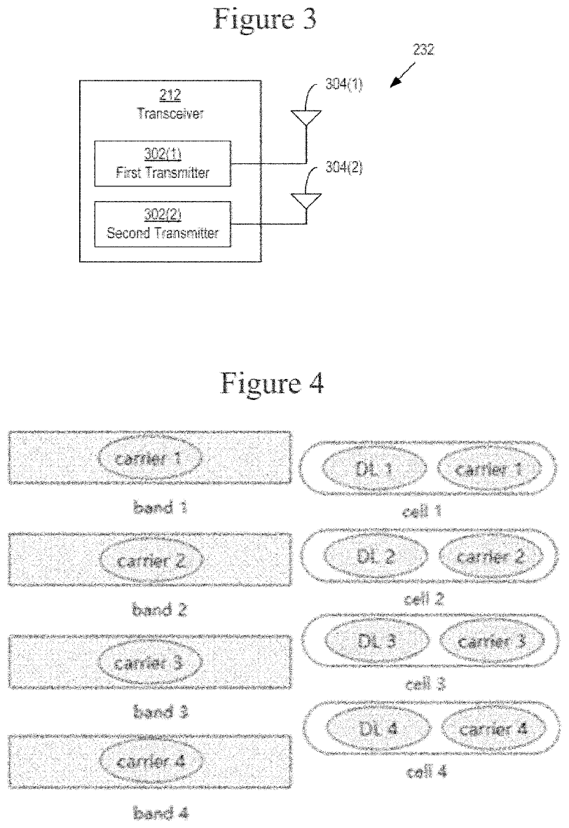

FIG. 3 shows a block diagram of an example configuration of the transceiver 212 and the antenna 232. In particular, the transceiver 212 includes a first transmitter (Tx) (or transmitter circuit) 302(1) and a second transmitter (Tx) (or transmitter circuit) 302(2). In addition, the antenna 232 may include a first antenna component 304(1) and a second antenna component 304(2). In general, the first transmitter 302(1) and the first antenna component 304(1) may form a first transmitter channel or chain, and the second transmitter 302(2) and the second antenna component 304(2) may form a second transmitter channel or chain. A UE 104, with the configuration in FIG. 2, may be configured to transmit a first UL transmission (or a first part of an UL transmission) using the first transmitter channel, and may be configured to transmit a second UL transmission (or a second part of a UL transmission) using the first transmitter channel.

In some embodiments, the UE 104 may use the two transmitter channels to transmit on one or two bands or carriers. The UE 104 may do so in any of various ways. For example, the UE 104 may transmit on a single carrier using both the first transmit channel and the second transmit channel. As another example, the UE 104 may transmit on a first carrier using the first transmit channel and on a second carrier using the second transmit channel. As used herein, the terms “1 Tx” and “1T” refer to use of one channel to transmit on one carrier, and the terms “2 Tx” and “2T” refer to the use of two transmit channels to transmit on one carrier. In addition, as used herein, the phrase “UL transmit case” refers to a particular configuration of the transmit channels used for an UL transmission on one or more carriers. Also, as described in further detail below, the UE 104 may switch between UL transmit cases during an UL Tx switching operation. Table 1 below lists two example UL transmit cases, Case 1 and Case 2.

TABLE 1
Example of UL Transmit Cases

| | |
|---|---|
| Case 1 | 1 Tx on carrier 1 and 1 Tx on carrier 2 |
| Case 2 | 0 Tx on carrier 1 and 2 Tx on carrier 2 |

Table 1 shows that for a first UL transmit case (Case 1), the UE 104 transmits an UL transmission on two carriers, using one transmit channel (1 Tx) for each carrier, such as by using a first transmit channel to transmit on a first carrier (carrier 1) and a second transmit channel to transmit on a second carrier (carrier 2). In addition, Table 1 shows that for a second UL transmit case (Case 2), the UE 104 transmits an UL transmission on only one carrier, using two transmit channel (2 Tx) to transmit on the second carrier. For this second case, the UE 104 does not use any transmit channels to transmit on the first carrier.

In addition, in various embodiments, the UE 104 may perform UL transmitter (Tx) switching to perform UL transmissions. In general, the UE 104 may perform UL Tx switching by switching from one UL transmit case to another UL transmit case. In operation, the UE 104 may transmit an UL transmission according to a first UL transmit case, and then may switch from the first UL transmit case to a second UL transmit case, and transmit an UL transmission according to the second UL transmit case. To illustrate, using Table 1 for example, the user device may transmit an UL transmission according to Case 1, such as by transmitting on the first carrier using the first transmitter chain and transmitting on the second carrier using the second transmitter channel. Then, the UE 104 may switch from Case 1 to Case 2, and then transmit an UL transmission according to Case 2, such as by transmitting on the second carrier using both the first and second transmitter channels.

In various embodiments, such as with reference to Table 1, the type of UL Tx switching that the UE 104 performs may be referred to as 1Tx-2Tx switching. For 1Tx-2Tx switching, the UE 104 may switch from using one transmitter channel to transmit on a channel to using two transmitter channels to transmit on a channel, or may switch from using two transmitter channels to one transmitter channel to transmit on a channel.

In addition, in various embodiments, UL transmit cases may also identify numbers of antenna ports corresponding to the carriers. The identification may be in the form of a mapping between carriers and respective numbers of antenna ports. For at least some of these embodiments, the numbers of antennas may depend on whether or not the UE 104 supports simultaneous transmission across a band pair. Table 2 shows example UL transmit cases when simultaneous transmission across a band pair is not supported, and further when the UE 104 applies carrier aggregation including a supplementary UL (SUL) band.

TABLE 2
Example of UL Transmit Cases with Antenna Port
Number Mapping where UE does not support simultaneous
transmission across a band pair

| | | Number of antenna ports |
|---|---|---|
| | Number of Tx chains in WID | for UL transmission |
| | (carrier 1 + carrier 2) | (carrier 1 + carrier 2) |
| Case 1 | 1T + 1T | 1P + 0P |
| Case 2 | 0T + 2T | 0P + 2P, 0P + 1P |

In the example illustrated in Table 2, for a first UL transmit case (Case 1), the UE 104 transmits on the first carrier using the first transmit channel, and transmits on the second carrier using the second transmit channel. Also, based on that the UE 104 does not support simultaneous transmission across a band pair, the number of antenna ports for the UL transmission on the first carrier is one, and the number of antenna ports for the UL transmission on the second carrier is zero (1P+0P). Additionally, in the example illustrated in Table 2, for a second UL transmit case (Case 2), the UE 104 transmits on the second carrier using both the first and second transmit channels. Also, based on that the UE 104 does not support simultaneous transmission across a band pair, the numbers of antenna ports for the two carriers can be one of two options. In a first option, the number of antenna ports for the first carrier is zero, and the number of antenna ports for the second carrier is two. In a second option, the number of antenna ports for the first carrier is zero, and the number of antenna ports for the second carrier is one.

Table 3 shows example UL transmit cases when simultaneous transmission across a band pair is supported.

TABLE 3
Example of UL Transmit Cases with Antenna Port Number Mapping
where UE supports simultaneous transmission across a band pair

| | | Number of antenna ports |
|---|---|---|
| | Number of Tx chains in WID | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |

In the example illustrated in Table 3, for a first UL transmit case (Case 1), the UE 104 transmits on the first carrier using the first transmit channel, and transmits on the second carrier using the second transmit channel. Also, based on that the UE 104 does support simultaneous transmission across a band pair, the number of antenna ports for the UL transmission can be one of three options. In a first option, the number of antenna ports for the first carrier is one, and the number of antenna ports for the second carrier is zero. In a second option, the numbers of antenna ports for the first and second carriers are each one. In a third option, the number of antenna ports for the first carrier is zero, and the number of antenna ports for the second carrier is one. In a second UL transmit case, the UE 104 does not transmit on the first carrier with any transmitter chains, and transmits on the second carrier with two transmitter chains. Also, based on that the UE 104 does support simultaneous transmission across a band pair, the number of antenna ports for the UL transmission can be one of two options. In a first option, the number of antenna ports for the first carrier is zero, and the number of antenna ports for the second carrier is two. In a second option, the number of antenna ports for the first carrier is zero, and the number of antenna ports for the second carrier is one.

As mentioned above, the UE 104 may perform 1Tx-2Tx UL Tx switching, where the UE 104 switches between one and two transmit channels for transmitting on a channel. Another type of UL Tx switching may include 2Tx-2Tx switching, where the UE 104 switches from using two transmitter channels to transmit on a carrier to using two transmitter channels to transmit on another carrier. Tables 4 and 5 below illustrate examples of 2Tx-2Tx UL Tx switching.

TABLE 4
First Example of UL Transmit Cases for 2Tx-2Tx Switching

| | Number of Tx chains in WID (carrier 1 + carrier 2) |
|---|---|
| Case 1 | 0T + 2T |
| Case 2 | 2T + 0T |

TABLE 5
Example of UL Transmit Cases combining
1Tx-2Tx and 2Tx-2Tx Switching

| | Number of Tx chains in WID (carrier 1 + carrier 2) |
|---|---|
| Case 1 | 1T + 1T |
| Case 2 | 0T + 2T |
| Case 3 | 2T + 0T |

With reference to Table 4, in the first example of 2Tx-2Tx UL Tx switching, in a first transmit case (Case 1), the UE 104 transmits on a second carrier using two transmitter channels, and does not transmit on a first carrier with any transmitter channels. In a second transmit case (Case 2), the UE 104 transmits on the first carrier using two transmitter channels, and does not transmit on the second carrier with any transmitter channels. For the 2Tx-2Tx UL Tx switching, the UE 104 may switch from the first transmit case to the second transmit case, or may switch from the second transmit case to the first transmit case.

With reference to Table 5, the UE 104 may use a combination of 1Tx-2Tx switching and 2Tx-2Tx switching. For example, in Table 5, Case 1 corresponds to Case 1 in Table 2, and Cases 2 and 3 correspond to Cases 1 and 2 in Table 4, respectively. The UE 104 may perform 1Tx-2Tx switching by switching between Cases 1 and 2 and/or Cases 1 and 3, and may perform 2Tx-2Tx switching by switching between Cases 2 and 3.

Also, in various embodiments, UL transmit cases may also identify numbers of antenna ports corresponding to the carriers for 2Tx-2Tx switching, such as in the form of mapping between carriers and respective numbers of antenna ports, similar to Tables 2 and 3 above, which shows mapping between carriers and numbers of antenna ports for 1Tx-2Tx switching. The mappings may depend on whether the UE 104 supports or does not support simultaneous switching across a band pair. Table 6, below, shows example UL transmit cases with numbers of antenna ports mapping for 2Tx-2Tx switching where the UE 104 does not support simultaneous transmission across a band pair. Table 7, below, shows example UL transmit cases with numbers of antenna port mapping for 2Tx-2Tx switching where the UE 104 supports simultaneous transmission across a band pair.

TABLE 6
Example of UL Transmit Cases with Antenna Port Number
Mapping for 2Tx-2Tx switching, where UE does not support
simultaneous transmission across a band pair

| | | Number of antenna ports |
|---|---|---|
| | Number of Tx chains in WID | for UL transmission |
| | (carrier 1 + carrier 2) | (carrier 1 + carrier 2) |
| Case 2 | 0T + 2T | 0P + 2P, 0P + 1P |
| Case 3 | 2T + 0T | 2P + 0P, 1P + 0P |

TABLE 7
Example of UL Transmit Cases with Antenna Port Number Mapping
for combination of 1Tx-2Tx and 2Tx-2Tx switching, where UE
supports simultaneous transmission across a band pair

| | | Number of antenna ports |
|---|---|---|
| | Number of Tx chains in WID | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |
| Case 3 | 2T + 0T | 2P + 0P, 1P + 0P |

Additionally, in various embodiments, the UE 104 may perform 1Tx-2Tx and/or 2Tx-2Tx UL Tx switching with respect to bands. For example, one carrier may be on one band (e.g., a band A), and two carriers, such as two contiguous carriers, may be on another band (e.g., a band B). For at least some of these embodiments, the band with the one carrier may be a supplementary UL (SUL) band, and the band with the two contiguous carriers may be a non-SUL or a normal UL (NUL) band. For at least some of these examples, the UE 104 may perform UL Tx switching between any two or three of the following cases for a first band and a second band (i.e., band A+band B): Case 1: 1T+1T; Case 2: 0T+2T; Case 3: 2T+0T.

Additionally, for embodiments where the UE 104 performs UL Tx switching with respect to bands, the UL transmit cases may identify numbers of antenna ports for the carriers of the bands, similar to Tables 2, 3, 6 and 7 above. Tables 8-11 show various UL transmit cases with of antenna port number mapping for two bands including three carriers, where a first band (band A) includes one carrier and a second band (band B) includes two contiguous carriers. Table 8 shows example UL transmit cases for 1Tx-2Tx UL Tx switching where the UE 104 does not support simultaneous transmission across a band pair. Table 9 shows example UL transmit cases for 1Tx-2Tx UL Tx switching where the UE 104 supports simultaneous transmission across a band pair. Table 10 shows example UL transmit cases for 2Tx-2Tx UL Tx switching where the UE 104 does not support simultaneous transmission across a band pair. Table 11 shows example UL transmit cases for 2Tx-2Tx UL Tx switching where the UE 104 supports simultaneous transmission across a band pair.

TABLE 8
Example UL transmit cases with Antenna Port Number Mapping for 1Tx-2Tx switching
where UE does not support simultaneous transmission across a band pair

| | Number of Tx chains in WID | Number of antenna ports for UL transmission (band A |
|---|---|---|
| | (band A + band B) | (carrier 1) + band B (carrier 2 + carrier 3)) |
| Case 1 | 1T + 1T | 1P + (0P + 0P) |
| Case 2 | 0T + 2T | 0P + (2P + 0P), 0P + (0P + 2P), 0P + (2P + 2P), 0P + (1P + 0P), |
| | | 0P + (0P + 1P), 0P + (1P + 1P), 0P + (1P + 2P), 0P + (2P + 1P) |

TABLE 9
Example UL transmit cases with Antenna Port Number Mapping for 1Tx-2Tx switching
where UE supports simultaneous transmission across a band pair

| | Number of Tx chains in WID | Number of antenna ports for UL transmission (band A |
|---|---|---|
| | (band A + band B) | (carrier 1) + band B (carrier 2 + carrier 3)) |
| Case 1 | 1T + 1T | 1P + (0P + 0P), 1P + (1P + 0P), 1P + (0P + 1P), 1P + (1P + 1P), |
| | | 0P + (1P + 0P), 0P + (0P + 1P), 0P + (1P + 1P) |
| Case 2 | 0T + 2T | 0P + (2P + 0P), 0P + (0P + 2P), 0P + (2P + 2P), 0P + (1P + 0P), |
| | | 0P + (0P + 1P), 0P + (1P + 1P), 0P + (1P + 2P), 0P + (2P + 1P) |

TABLE 10
Example UL transmit cases with Antenna Port Number Mapping for 2Tx-2Tx switching
where UE does not support simultaneous transmission across a band pair

| | Number of Tx chains in WID | Number of antenna ports for UL transmission (band A |
|---|---|---|
| | (band A + band B) | (carrier 1) + band B (carrier 2 + carrier 3)) |
| Case 2 | 0T + 2T | 0P + (2P + 0P), 0P + (0P + 2P), 0P + (2P + 2P), 0P + (1P + 0P), |
| | | 0P + (0P + 1P), 0P + (1P + 1P), 0P + (1P + 2P), 0P + (2P + 1P) |
| Case 3 | 2T + 0T | 2P + (0P + 0P), 1P + (0P + 0P) |

TABLE 11
Example UL transmit cases with Antenna Port Number Mapping for 2Tx-2Tx switching
where UE supports simultaneous transmission across a band pair

| | Number of Tx chains in WID | Number of antenna ports for UL transmission (band A |
|---|---|---|
| | (band A + band B) | (carrier 1) + band B (carrier 2 + carrier 3)) |
| Case 1 | 1T + 1T | 1P + (0P + 0P), 1P + (1P + 0P), 1P + (0P + 1P), 1P + (1P + 1P), |
| | | 0P + (1P + 0P), 0P + (0P + 1P), 0P + (1P + 1P) |
| Case 2 | 0T + 2T | 0P + (2P + 0P), 0P + (0P + 2P), 0P + (2P + 2P), 0P + (1P + 0P), |
| | | 0P + (0P + 1P), 0P + (1P + 1P), 0P + (1P + 2P), 0P + (2P + 1P) |
| Case 3 | 2T + 0T | 2P + (0P + 0P), 1P + (0P + 0P) |

In some embodiments, the UE 104 may be configured with three bands for which to perform UL Tx switching and within which to transmit UL transmissions. The three bands may include a first band (band A), a second band (band B), and a third band (band C). For at least some of these embodiments, the UE 104 may dynamically select any two of these three bands to perform UL Tx switching. In various of these embodiments, the three bands may include various combination of SUL bands and normal or non-SUL (NUL) bands, examples of two scenarios are as follows.
In a first scenario (Scenario 1): Band A is a SUL band or a non-SUL band, band B is a non-SUL band, and band C is a SUL band or a non-SUL band. That is, band C is similar as band A. In one example of Scenario 1, band A includes a first carrier (carrier 1), band B includes a second carrier (carrier 2), and band C includes a third carrier (carrier 3). In a second example of Scenario 1, band A includes carrier 1, band B includes carriers 2 and 3, and band C includes a fourth carrier (carrier 4).
In a second scenario (Scenario 2), band A is a SUL band or a non-SUL band, band B is a non-SUL band, and band C is a non-SUL band. That is, band C is similar as band B. In one example of Scenario 2, band A includes carrier 1, band B includes carrier 2, and band C includes carriers 3 and 4. In a second example of Scenario 2, band A includes carrier 1, band B includes carriers 2 and 3, and band C includes carrier 4 and a fifth carrier (carrier 5).

Additionally, in various other embodiments, the UE 104 may be configured with four bands, including a first band (band A), a second band (band B), a third band (band C), and a fourth band (band D), for which to perform UL Tx switching and within which to transmit UL transmissions. Similar to the three-band configurations, the UE 104 may dynamically select any two of the four bands to perform UL Tx switching. In various of these embodiments, the four bands may include various combinations of SUL and NUL bands, examples of two scenarios are as follows.
In a first scenario (Scenario 1), band A is a SUL band or a non-SUL band, band B is a non-SUL band, and band C is a SUL band or a non-SUL band. That is, band C is similar as band A. In a first example of Scenario 1, band includes a first carrier (carrier 1), band B includes a second carrier (carrier 2), band C includes a third carrier (carrier 3), and band D includes a fourth carrier (carrier 4). In a second example of Scenario 1, band A includes carrier 1, band B includes carrier 2, band C includes carrier 3, and band D includes carrier 4 and a fifth carrier (carrier 5). In a third example of Scenario 1, band A includes carrier 1, band B includes carriers 2 and 3, band C includes carrier 4, and band D includes carrier 5. In a fourth example of Scenario 1, band A includes carrier 1, band B includes carriers 2 and 3, band C includes carrier 4, and band D includes carrier 5 and a sixth carrier (carrier 6).
In a second scenario (Scenario 2), band A is a SUL band or a non-SUL band, band B is a non-SUL band, and band C is a non-SUL band. That is band C is similar as band B. In a first example of Scenario 2, band A includes carrier 1, band B includes carrier 2, band C includes carriers 3 and 4, and band D includes carrier 5. In a second example of Scenario 2, band A includes carrier 1, band B includes carrier 2, band C includes carriers 3 and 4, and band D includes carriers 5 and 6. In a third example of Scenario 2, band A includes carrier 1, band B includes carriers 2 and 3, band C includes carriers 4 and 5, and band D includes carrier 6. In a fourth example of Scenario 2, band A includes carrier 1, band B includes carriers 2 and 3, band C includes carriers 4 and 5, and band D includes carriers 6 and 7.

Also, for embodiments where the UE 104 performs dynamic Tx carrier switching across the configured bands, at least one of the following options. In a first option, the UE 104 may perform dynamic Tx carrier switching across all the supported UL transmission cases supported by the UE and based on UL scheduling, i.e., via UL grant and/or RRC configuration for UL transmission. In a second option, the basestation 102 may indicate two bands out of the configured bands (3 or 4 bands) via DCI or medium access control (MAC) control element (CE). In a third option, the UE 104 may select one anchor band among the configured bands (3 or 4 bands), and may perform dynamic Tx carrier switching only from the anchor band to a non-anchor band and/or from a non-anchor band to the anchor band.

Table 12 shows an example set of ten UL transmit cases for four bands with antenna port number mapping. The second column in Table 12 indicates the antenna port numbers for when the UE 104 does not support simultaneous transmission across multiple carriers, and the third column indicates the antenna port numbers for when the UE 104 supports simultaneous transmission across up to two carriers.

TABLE 12
Example switching cases for switching configuration with four UL bands with antenna port
number mapping, where the UE does not support simultaneous transmission across multiple
carriers and does support simultaneous transmission across up to two carriers

| | Number of Tx | Number of antenna ports in band A, B, | Number of antenna ports in band A, |
|---|---|---|---|
| | chains in band | C and D (option 1: no simultaneous | B, C and D (option 2: simultaneous |
| | A, B, C and D | transmission across multiple carriers) | transmission across up to 2 carriers) |
| Case 1 | 1T + 1T + 0T + 0T | n/a | 1P + 0P + 0P + 0P, 1P + 1P + 0P + 0P, |
| | | | 0P + 1P + 0P + 0P |
| Case 2 | 0T + 2T + 0T + 0T | 0P + 2P + 0P + 0P, 0P + 1P + 0P + 0P | 0P + 2P + 0P + 0P, 0P + 1P + 0P + 0P |
| Case 3 | 2T + 0T + 0T + 0T | 2P + 0P + 0P + 0P, 1P + 0P + 0P + 0P | 2P + 0P + 0P + 0P, 1P + 0P + 0P + 0P |
| Case 4 | 1T + 0T + 1T + 0T | n/a | 1P + 0P + 0P + 0P, 1P + 0P + 1P + 0P, |
| | | | 0P + 0P + 1P + 0P |
| Case 5 | 1T + 0T + 0T + 1T | n/a | 1P + 0P + 0P + 0P, 1P + 0P + 0P + 1P, |
| | | | 0P + 0P + 0P + 1P |
| Case 6 | 0T + 1T + 1T + 0T | n/a | 0P + 1P + 0P + 0P, 0P + 1P + 1P + 0P, |
| | | | 0P + 0P + 1P + 0P |
| Case 7 | 0T + 1T + 0T + 1T | n/a | 0P + 1P + 0P + 0P, 0P + 1P + 0P + 1P, |
| | | | 0P + 0P + 0P + 1P |
| Case 8 | 0T + 0T + 1T + 1T | n/a | 0P + 0P + 1P + 0P, 0P + 0P + 1P + 1P, |
| | | | 0P + 0P + 0P + 1P |
| Case 9 | 0T + 0T + 2T + 0T | 0P + 0P + 2P + 0P, 0P + 0P + 1P + 0P | 0P + 0P + 2P + 0P, 0P + 0P + 1P + 0P |
| Case 10 | 0T + 0T + 0T + 2T | 0P + 0P + 0P + 2P, 0P + 0P + 0P + 1P | 0P + 0P + 0P + 2P, 0P + 0P + 0P + 1P |

For embodiments where the UE 104 supports all UL transmit cases (e.g., all ten UL transmit cases in Table 12) in accordance with the first option above, the UE 104 may switch between any two UL transmit cases without any additional restrictions. For example, suppose a current transmit state of the UE 104 is to transmit on two carriers on two bands using one transmit channel to transmit on each band, and the UE 104 is to switch two different carriers on two different bands but still using one transmit channel to transmit on each band. For example, the UE 104 may switch from Case 1 to Case 8. Corresponding to Cases 1 and 8 in Table 12, the UE 104 may transmit a first transmission on carrier 1 in cell 1 and on carrier 2 in cell 2 (Case 1), and then switch and transmit a second transmission on carrier 3 in cell 3 and carrier 4 in cell 4 (Case 8).

The mechanism for dynamic Tx carrier switching across the configured bands may be Dynamic Tx carrier switching can be across all the supported switching cases by the UE and based on the UL scheduling, i.e., via dynamic grant and/or RRC configuration for UL transmission. In an embodiment for the “all the supported switching cases” are the all entries of the ‘superset’ as shown in Table 12, that there are no additional restrictions. For example, if current Tx state is the two carriers on two bands with 1Tx on each band, are switched to two carriers on another two bands with 1Tx on each band, that is Tx switching between case 1 and case 8, which can be regarded as UL transmission on carrier 1 in cell 1 and carrier 2 in cell 2 are switched to carrier 3 in cell 3 and carrier 4 in cell 4 as shown in FIG. 4. FIG. 4 shows a block diagram illustrating relationships between carriers, bands, and cells.

Two bands can be configured for UE to do TX switching. Two bands are band A (e.g. carrier 1) is for SUL or non-SUL and band B (only carrier 2, or carrier 2 and carrier 3) is a non-SUL band. In examples with three bands (e.g. band A+band B+band C) are configured. Only two bands may be dynamically selected out to perform UL TX switching. Assuming band C may be similar as band A or band B, then the following alternatives could be derived. The following describe various embodiments related to restrictions or criteria for how to configure or determine the cells/carriers/bands among three or four bands for UL Tx switching, and how to report or configure switching within three or four bands, including for configurations where the UE 104 does and does not support simultaneous transmission across a band pair.

In embodiments where one of the two Tx chains are triggered to switch from one band (e.g. “band A”) to another band (e.g. “band B”), the other Tx chain may be maintained on a different band (e.g. “band C”) and the number of Tx chain on band C may be unchanged due to the switching. The baseline UE assumption may be that neither of Tx chains is expected to be used for transmission during the switching period. An optional UE capability allows the UL transmission on the band with the number of Tx chain unchanged (i.e., one Tx chain is maintained on the band) during the UL switching. The embodiments described herein determine the timeline to apply this optional UE capability. In embodiments where the UE is to transmit a 1-port+1-port (1P+1P) transmission each on one UL carrier on different bands (e.g. 1st and 2nd band) and if Tx chain state at the preceding uplink transmission is 1T+1T each on a carrier on other different bands (e.g. 3rd and 4th band), some embodiments determine the timeline to implement it as one Tx switching. For simplicity, the following embodiments focus on one example timeline issue with three or four band switching. There may be other embodiments that are also related to 3Tx involved switching.

In some embodiments, there may be an uplink switching gap N_{Tx1-Tx2}. The UE may omit uplink transmission during the uplink switching gap N_{Tx1-Tx2} if the conditions defined in this clause are met and the UE is configured with uplinkTxSwitching. The switching gap N_{Tx1-Tx2} may be indicated by UE capability uplinkTxSwitchingPeriod2T2T if uplinkTxSwitching-2T-Mode is configured, or with uplinkTxSwitchingPeriod. For the UE configured with uplinkTxSwitchingOption set to ‘switchedUL’, when the UE is to transmit a 1-port transmission on one uplink carrier on one band and if the preceding uplink transmission was a 1-port transmission on another uplink carrier on another band, then the UE may not be expected to transmit for the duration of N_{Tx1-Tx2} on any of the carriers. In some embodiments, the UE is expected to transmit normally all uplink transmissions without interruptions. There may be an uplink switching period, such as in the RAN4 specification. The switching period may be located in either NR carrier 1 or carrier 2 as indicated in RRC signalling uplinkTxSwitchingPeriodLocation, and the length of uplink switching period X may be less than the value indicated by UE capability uplinkTxSwitchingPeriod.

The UE may first report the band combination to the basestation (the band combination may including many bands, e.g. 5 bands), wherein the band combination signaling further includes one or more band pair with each band pair including 2 bands. For example, the basestation may configure PCell and SCell for the UE, wherein the PCell and SCell may satisfy coming from one band pair. The switching period may be reported per band pair. For each switching between the two cases, that is up to 2 Tx switching between 2 carriers within a band pair, the switching period may be one of {35 us, 140 us, 210 us} which is reported per band pair by a UE.

The switching option may be reported per band combination. For example, ‘switchedUL’ or ‘dualUL’ or ‘both’ may be reported by UE per band combination (BC), and supportedBandPairListNR may also be reported for the BC. For example, ‘switchedUL’ or ‘dualUL’ may be configured by the basestation per cell group, which may be regarded as per BC or per band pair. One available band pair in the BC may support one type of carrier aggregation (CA) option, different CA options may be applied when RRC reconfiguration if UE reports ‘both’. CA option 1 may be ‘switchedUL’, that is concurrent transmission across 2 bands is not supported, while CA option 2 is ‘dualUL’, that is concurrent transmission across 2 bands is supported.

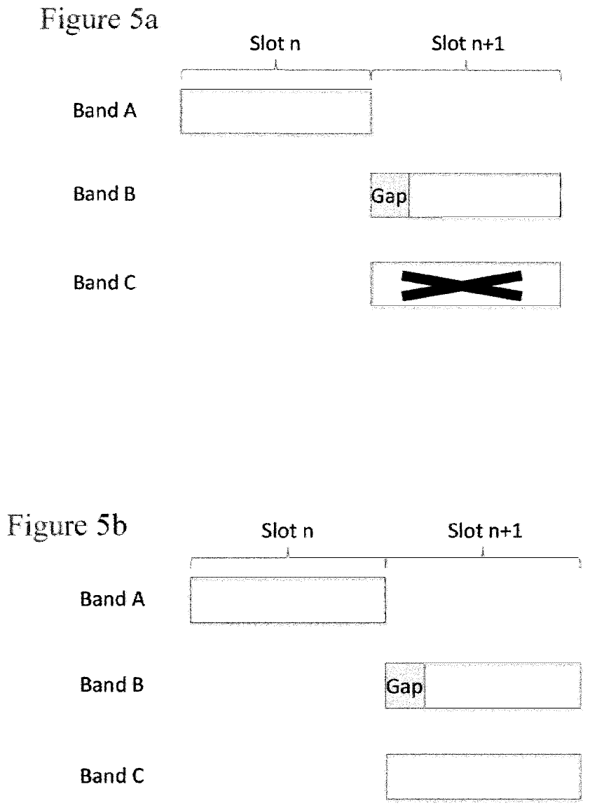

FIG. 5a shows an embodiment of a User Equipment (UE) baseline assumption. When the UE is to transmit a 1-port transmission on one uplink carrier on one band and if the preceding uplink transmission was a 1-port transmission on another uplink carrier on another band, then the UE may not be expected to transmit for the duration of N_{Tx1-Tx2} on any of the carriers. As shown Band C has not communication.

FIG. 5b shows an embodiment of a User Equipment (UE) optional capability. The UE optional capacity includes communications in Band C being enabled. The embodiments described below include examples of a timeline for utilizing the UE optional capacity. In one embodiment, there may be three bands A,B,C that are the configured bands to perform Tx switching as shown in Table 13.

TABLE 13
Transmission chain configuration with
assumed number of Tx per band

| | Number of Tx Chains |
|---|---|
| | (Band A + Band B + Band C) |
| Case 1-1 | 1T + 1T + 0T |
| Case 1-2 | 0T + 1T + 1T |
| Case 1-3 | 1T + 0T + 1T |
| Case 2-1 | 2T + 0T + 0T |
| Case 2-2 | 0T + 2T + 0T |
| Case 2-3 | 0T + 0T + 2T |

In one embodiment, the transmission switching option parameter (e.g. uplinkTxSwitchingOption) may be set to ‘switchUL’, and may also be named as CA option 1 which means the concurrent transmission between two bands is not supported, which can be also applied for SUL scenario. In an alternative, the transmission switching option parameter (e.g. uplinkTxSwitchingOption) may be set to ‘dualUL’, and may also be named as CA option 2 which means the concurrent transmission between two bands is supported. Under the ‘switchUL’ operation, the uplink transmission can be performed on one band before or after switching within band combination A&B&C. The switching period is reported for each band pair A&B, band pair B&C, and band pair A&C respectively with same or different value. Under the ‘dualUL’ operation, the uplink transmission can be performed on one or two bands before or after switching within band combination A&B&C. The switching period is reported for each band pair A&B, band pair B&C, and band pair A&C respectively with same or different value, and the switching gap is determined by the larger one of the two switching periods if two band pairs involved for the UL Tx switching. In embodiments with SUL or CA switched UL, Tx switching of 1P on band A switched to 1P on band B, 1P on band C transmission may not be expected based on the baseline UE assumption. Alternatively, when switching A-B is first triggered, UE may not be expected for UL transmission on band C overlapped with gap. In other words, the scheduling may not be expected or UE may omit/cancel UL transmission on band C. Alternatively, if UL transmission on band C is first scheduled, switching A-B may lead to “UE may omit/cancel UL transmission on band C.”

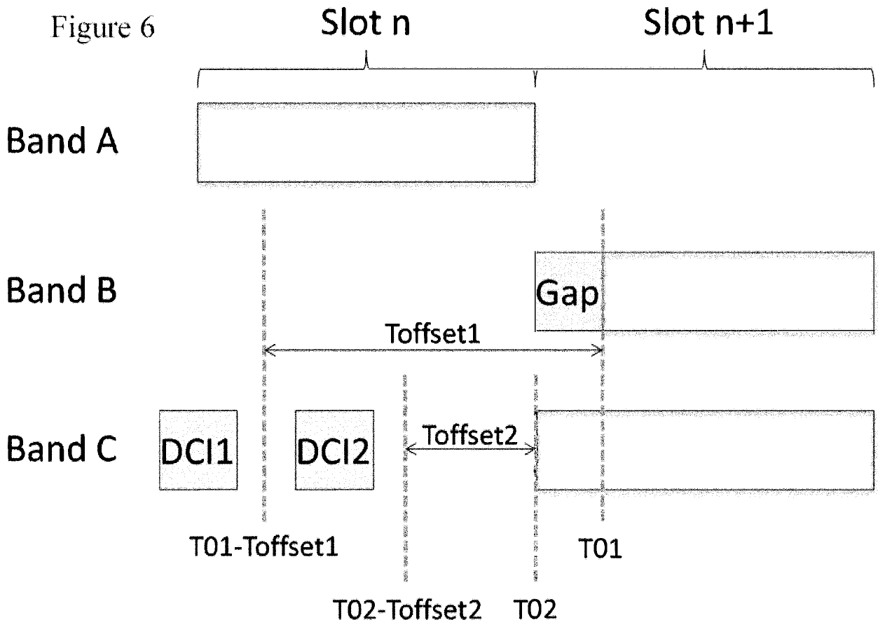

FIG. 6 shows an uplink (UL) transmission on band C overlapped with a gap of switching between Band A and Band B. If an uplink switching is triggered for an uplink transmission starting at T0, after T0-Toffset, the UE may not be expected to cancel the uplink switching, or to trigger any other new uplink switching occurring before T0 for any other uplink transmission that is scheduled after T0-Toffset. Toffset may be the UE processing procedure time defined for the uplink transmission triggering the switch (e.g. UE PUSCH preparation procedure time). For the Baseline UE assumption (e.g. FIG. 5a), neither of the Tx chains may be expected to be used for transmission on band C during the switching period. While for the Optional UE capability (e.g. FIG. 5b), the UL transmission on the band C with the number of Tx chain unchanged (i.e., one Tx chain is maintained on the band) may be allowed during UL switching from band A to band B, or band A+C to B+C.

There may be timeline restrictions to be applied to the optional UE capability (e.g. FIG. 5b). In a first option embodiment, DCI used for triggering the UL transmission on band C before T0-Toffset can be applied, wherein TO and Toffset is referred to the uplink transmission on band B after UL Tx switching. As shown in FIG. 6, the T0 is T01, and Toffset is Toffset1. In other words, DCI1 may be used to schedule UL transmission on band C if UL transmission on band C is overlapped with the gap of UL switching from Band A to Band B. In other words, DCI2 may not be used to schedule UL transmission on band C if UL transmission on band C is overlapped with the gap of UL switching from Band A to Band B. If there is no UL Tx switching from Band A to Band B, the DCI2 used for triggering the UL transmission on band C before T02-Toffset2 may be applied. This example embodiment may be applied for the optional UE capability (e.g. FIG. 5b) and with the timeline restriction that only DCI for trigger UL transmission on band C before T0-Toffset of uplink transmission on the other band after UL Tx switching is valid.

In a second option embodiment, a DCI may be used for triggering the UL transmission on band C before T0-Toffset can be applied, wherein TO and Toffset is referred to the uplink transmission on band C. As shown in FIG. 6, for this embodiment, the T0 is T02, and Toffset is Toffset2. In other words, DCI1 or DCI2 may be used to schedule UL transmission on band C if UL transmission on band C is overlapped with the gap of UL switching from Band A to Band B. If there is no UL Tx switching from Band A to Band B, the DCI2 used for triggering the UL transmission on band C before T02-Toffset2 may be applied. This example embodiment may be applied the optional UE capability and with the timeline restriction based on UL transmission on band C, regardless of switching from band A to band B.

In a third option embodiment, only the DCI used for triggering the UL transmission on band C after T0-Toffset of band B (and before T0-Toffset of band C) may apply the optional UE capability. The TO and Toffset of band B may be T01 and Toffset1. TO and Toffset of band C may be T02 and Toffset2. In other words, DCI1 may not be used to schedule UL transmission on band C if UL transmission on band C is overlapped with the gap of UL switching from Band A to Band B. DCI2 may be used to schedule UL transmission on band C if UL transmission on band C is overlapped with the gap of UL switching from Band A to Band B. If there is no UL Tx switching from Band A to Band B, the DCI2 used for triggering the UL transmission on band C may be before T02-Toffset2 can be applied. This example embodiment may be for baseline assumption (e.g. FIG. 5a) when the UL Tx switching may not be cancelled, the overlapping between UL transmission on band C and switching gap of band A and band B may be supported.

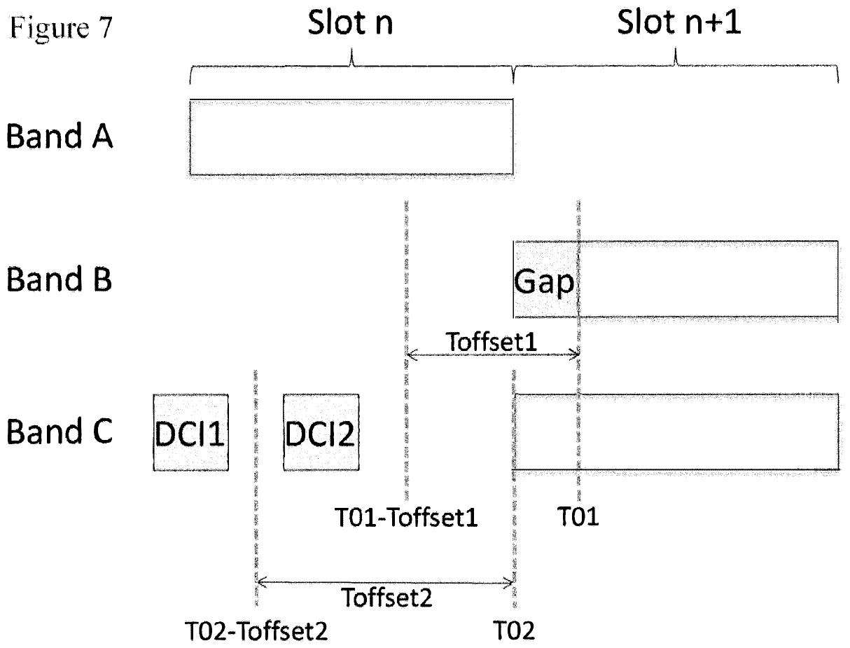

FIG. 7 shows another example uplink (UL) transmission on band C overlapped with a gap of switching between Band A and Band B. FIG. 7 illustrates a fourth option embodiment in which DCI used for triggering an uplink switching of the UL transmission on band B before T0-Toffset can be applied, where TO and Toffset is referred to the uplink transmission on band C. As shown in FIG. 7, the T0 is T02, and Toffset is Toffset2. DCI1 may be used to trigger an uplink switching of UL transmission on band B if UL transmission on band C is overlapped with the gap of UL switching from Band A to Band B. DCI2 may not be used to trigger an uplink switching of UL transmission on band B if UL transmission on band C is overlapped with the gap of UL switching from Band A to Band B. If there is no UL transmission on band C which is overlapped with the gap of UL switching from Band A to Band B, the DCI2 may be used to trigger an uplink switching of UL transmission on band B before T01-Toffset1 can be applied. This embodiment may be applied for the optional UE capability and with the timeline restriction that only the DCI for triggering an UL Tx switching of UL transmission on band B before T0-Toffset of uplink transmission on band C overlapping with the gap of the UL Tx switching is valid.

In a fifth option embodiment, the timeline is from view of UL Tx transmission on Band B rather than Band C. UE may operate the UE optional capability for UL Tx on Band B, and this example has restrictions on Band B. DCI is used for triggering an uplink switching of the UL transmission on band B before T0-Toffset can be applied, where TO and Toffset is referred to the uplink transmission on band B. As shown in FIG. 7, the T0 and Toffset is referred to the uplink transmission on band B is T01 and Toffset1. DCI1 or DCI2 may be used to trigger an uplink switching of UL transmission on band B if UL transmission on band C is overlapped with the gap of UL switching from Band A to Band B. If there is no UL transmission on band C, which is overlapped with the gap of UL switching from Band A to Band B, the DCI2 may be used to trigger an uplink switching of UL transmission on band B before T01-Toffset1 can be applied. This example embodiment is applied the optional UE capability and with the timeline restriction only based on UL transmission on band B, regardless of UL transmission on band C.

In a sixth option embodiment, the timeline is from view of UL Tx transmission on Band B rather than Band C. The DCI used for triggering an uplink switching of the UL transmission on band B after T0-Toffset of band C (and before T0-Toffset of band B) could apply the optional UE capability. As shown in FIG. 7, the T0 and Toffset of band B is T01 and Toffset1. TO and Toffset of band C is T02 and Toffset2. DCI1 may not be used to trigger an uplink switching of UL transmission on band B if UL transmission on band C is overlapped with the gap of UL switching from Band A to Band B. DCI2 may be used to trigger an uplink switching of UL transmission on band B if UL transmission on band C is overlapped with the gap of UL switching from Band A to Band B. If there is no UL transmission on band C which is overlapped with the gap of UL switching from Band A to Band B, the DCI2 used to trigger an uplink switching of UL transmission on band B before T01-Toffset1 may be applied. This example embodiment may be for using baseline assumption when the UL transmission on band C may not be cancelled which is overlapped with the gap of UL switching from Band A to Band B, and the overlapping between UL transmission on band C and switching gap of band A and Band B may be supported.

With some timeline restriction to apply the optional UE capability of supporting the overlapping between UL transmission on band C and the switching gap of band A and band B, the UE may have enough time to process the optional UE capability. It may be beneficial to avoid a lack of time to process the overlapping between UL transmission on band C and switching gap of band A and band B.

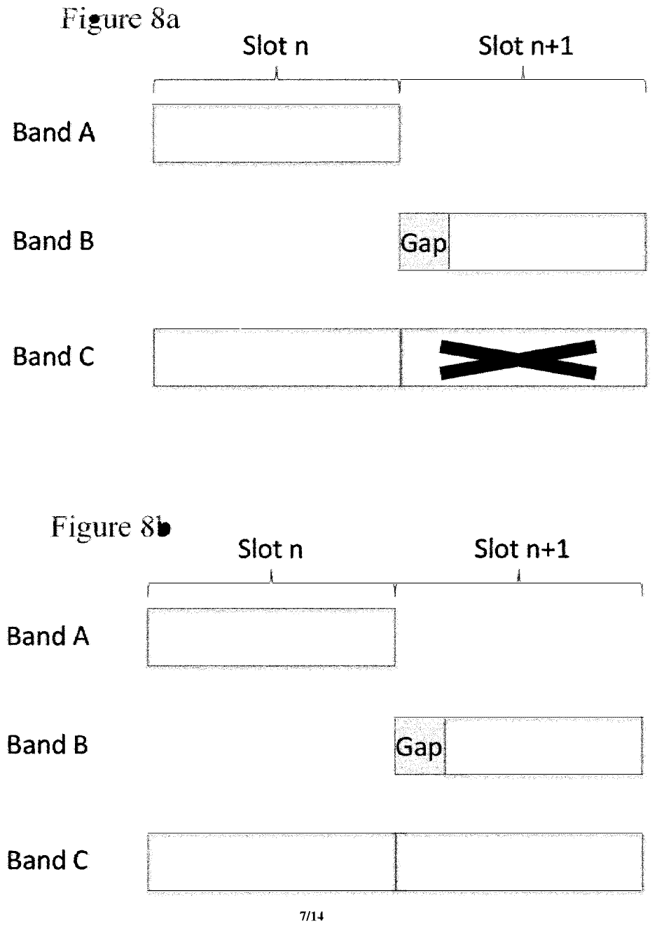

FIG. 8a shows an embodiment of a User Equipment (UE) baseline assumption with simultaneous transmission. As compared with FIG. 5a, FIG. 8a illustrates that Band C may have communication during Slot n. This may be referred to as simultaneous transmission. Specifically, FIG. 8a shows a baseline UE assumption.

FIG. 8b shows an embodiment of a User Equipment (UE) optional capability with simultaneous transmission. As compared with FIG. 5b, FIG. 8b illustrates that Band C may have communication during Slot n. This may be referred to as simultaneous transmission. Specifically, FIG. 8b shows UE optional capacity that includes communications in Band C being enabled in Slot n+1. The embodiments described below include examples of a timeline for utilizing the UE optional capacity with concurrent transmission as shown in FIG. 8b.

For concurrent transmission is supported for the UL Tx switching, concurrent UL transmissions on two different bands may be valid. A consideration is whether the UL Tx on band C can overlap with the gap on Band B. Timeline restrictions for operation may be similar to those discussed with respect to FIGS. 5a-7. The transmission switching option parameter (e.g. uplinkTxSwitchingOption) may be set to ‘dualUL’, and can be also named as CA option 2 which means the simultaneous transmission between two bands is supported. Under the ‘dualUL’ operation, the uplink transmission may be performed on one or two bands before or after switching within band combination band A, band B, and band C. The switching period is reported for each band pair band A and band B, band pair band B and band C, and band pair band A and band C, respectively, with a same or different value. The switching period is reported for each band pair A&B, band pair B&C, and band pair A&C respectively with same or different value, and the switching gap is determined by the larger one of the two switching periods if two band pairs involved for the UL Tx switching. The 4 bands example may also be applied. In a dual UL example, Tx switching of 1P+1P on band A+C switched to 1P+1P on band B+C, 1P on band C transmission may not be expected based on the baseline UE assumption.

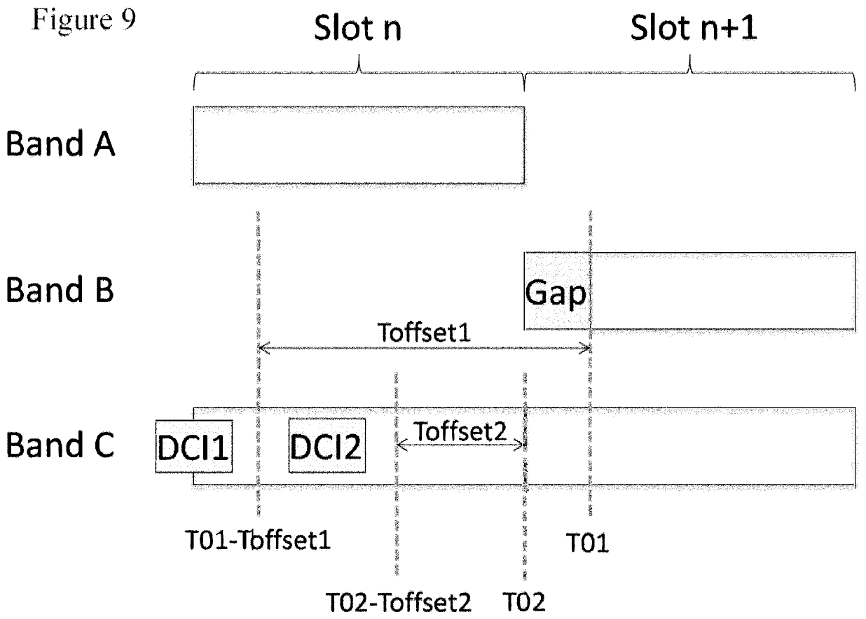

FIG. 9 shows an example uplink (UL) transmission on band C overlapped with a gap of switching with simultaneous transmission. If an uplink switching is triggered for an uplink transmission starting at TO, after T0-Toffset, the UE is not expected to cancel the uplink switching, or to trigger any other new uplink switching occurring before TO for any other uplink transmission that is scheduled after T0-Toffset, where Toffset is the UE processing procedure time defined for the uplink transmission triggering the switch (i.e. UE PUSCH preparation procedure time). For the Baseline UE assumption (e.g. FIG. 8a), neither of Tx chains is expected to be used for transmission on band C during the switching period. While for the Optional UE capability (e.g. FIG. 8b), UL transmission on the band C with the number of Tx chain unchanged (i.e., one Tx chain is maintained on the band) is allowed during UL switching band A+C to B+C.

There may be timeline restrictions to be applied to the optional UE capability (e.g. FIG. 8b). In a first option embodiment, DCI used for triggering the UL transmission on band C before T0-Toffset can be applied, where TO and Toffset may be referred to the uplink transmission on band B or with a gap located after UL Tx switching. As shown in FIG. 9, the TO is T01, and Toffset is Toffset1. DCI1 may be used to trigger UL transmission on band C if UL transmission on band C is overlapped with the gap of UL switching A+C to B+C. DCI2 may not be used to trigger UL transmission on band C if UL transmission on band C is overlapped with the gap of UL switching A+C to B+C. If there is no UL Tx switching A+C to B+C, the DCI2 may be used for triggering the UL transmission on band C before T02-Toffset2 can be applied. This example embodiment may be applied for the optional UE capability and with the timeline restriction that only DCI for trigger UL transmission on band C before T0-Toffset of uplink transmission on the other band after UL Tx switching is valid.

In a second option embodiment, a DCI may be used for triggering the UL transmission on band C before T0-Toffset can be applied, where TO and Toffset may be referred to the uplink transmission on band C. As shown in FIG. 9, TO is T02, and Toffset is Toffset2. DCI1 or DCI2 can be used to trigger UL transmission on band C if UL transmission on band C is overlapped with the gap of UL switching bands A+C to bands B+C. If there is no UL Tx switching of bands A+C to bands B+C, the DCI2 may be used for triggering the UL transmission on band C before T02-Toffset2 can be applied. This example embodiment may be applied to the optional UE capability and with the timeline restriction based on UL transmission on band C, regardless of switching from band A+C to band B+C.

In a third option embodiment, DCI used for triggering the UL transmission on band C after T0-Toffset of band B (and before T0-Toffset of band C) could apply the optional UE capability. As shown in FIG. 9, the T0 and Toffset of band B is T01 and Toffset1. TO and Toffset of band C is T02 and Toffset2. DCI1 may not be used to schedule UL transmission on band C if UL transmission on band C is overlapped with the gap of UL switching bands A+C to bands B+C. DCI2 may be used to schedule UL transmission on band C if UL transmission on band C is overlapped with the gap of UL switching bands A+C to bands B+C. If there is no UL Tx switching of bands A+C to bands B+C, the DCI2 may be used for triggering the UL transmission on band C before T02-Toffset2 can be applied. This example embodiment may be for using the baseline assumption (e.g. FIG. 8a), when the UL Tx switching cannot be cancelled, the overlapping between UL transmission on band C and switching gap of bands A+C to bands B+C can be supported.

In a fourth option embodiment, the DCI may be used for triggering the UL transmission on band C before the T0-Toffset could apply the optional UE capability. Wherein the T0 and Toffset is referred to the earlier/earliest uplink transmission of band B and band C with overlapping between UL transmission on band C and switching gap located on band B.

In a fifth option embodiment, the optional UE capability may be only used for switched UL. For dual UL switching case 1P+1P on band A and C to 1P+1P on band B and C, the switching gap is applied for both bands regardless 1T on band C is changed or not.

In these embodiments, with some timeline restriction to apply the optional UE capability of supporting the overlapping between UL transmission on band C and switching gap of band A and B, the UE may have enough time to process the optional UE capability. It may be a benefit to avoid lack of time to process the overlapping between UL transmission on band C and switching gap of band A and B.

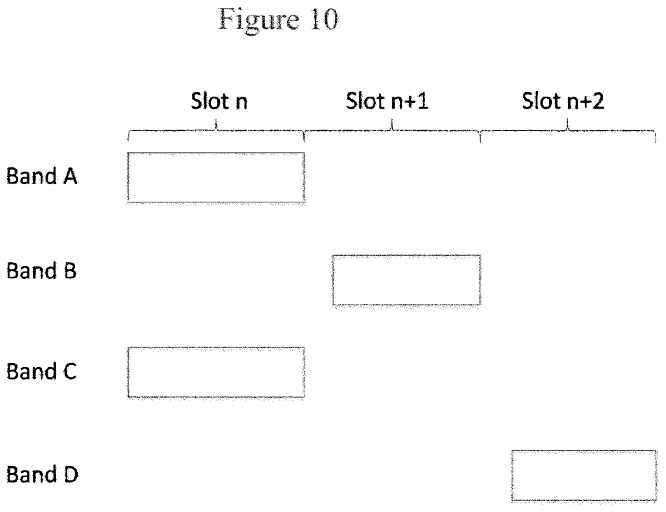

FIG. 10 shows an embodiment with four bands. The switching may be one Tx switching of band A+C switching to band B+D, or one Tx switching of band A switching to band B and one Tx switching of band C switching to band D. This embodiment may define one Tx switching, which can be performed in 3 or 4 bands. Embodiments described below include a timeline where the basestation and UE understand that this is a single Tx switching among more than one band.

When a UE is triggered to perform TX switching between a band pair, and the start of the UL transmission after TX switching is TO, the UE uses grants received before T0-Toffset to determine how to perform switching, where Toffset is the UE processing procedure time defined for the uplink transmission triggering. Based on the grants, if the two Tx chains are triggered to switch between two different band pairs (e.g., band A+band C to band B+band D), when the condition is satisfied, UE perform it as one TX switching involving more than two bands, otherwise as twice of the TX switching. There may be several embodiment options for implementation.

In a first option embodiment, the two UL transmissions after Tx switching is partial overlapped or the gap of the two UL transmissions is less than a value. The gap of the two UL transmissions means the end of one UL transmission and the start of the other UL transmission. The UE may perform 1 UL Tx switching or 2 UL Tx switching. There may be restrictions if there is just 1 UL Tx switch as described below. If restriction is not satisfied, then there may be two UL Tx switchings.

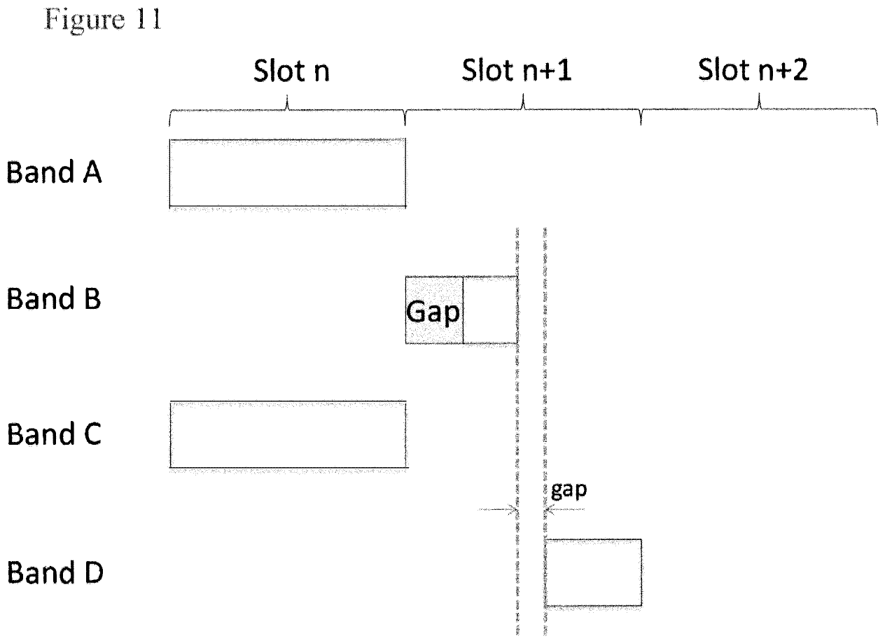

FIG. 11 shows an example uplink (UL) transmission on four bands with a gap of switching. This example may include an example with less than the switching gap. If the two UL transmissions after TX switching are not overlapped but the gap is less than switching gap (e.g. Bands B and D are not overlapped). When one slot is only permitted one UL Tx switching; the gap between two UL transmissions may be less than the switching gap and is similar as a partial overlapped case. In alternative embodiments, less than the switching gap and the two UL transmissions may be within a same slot.

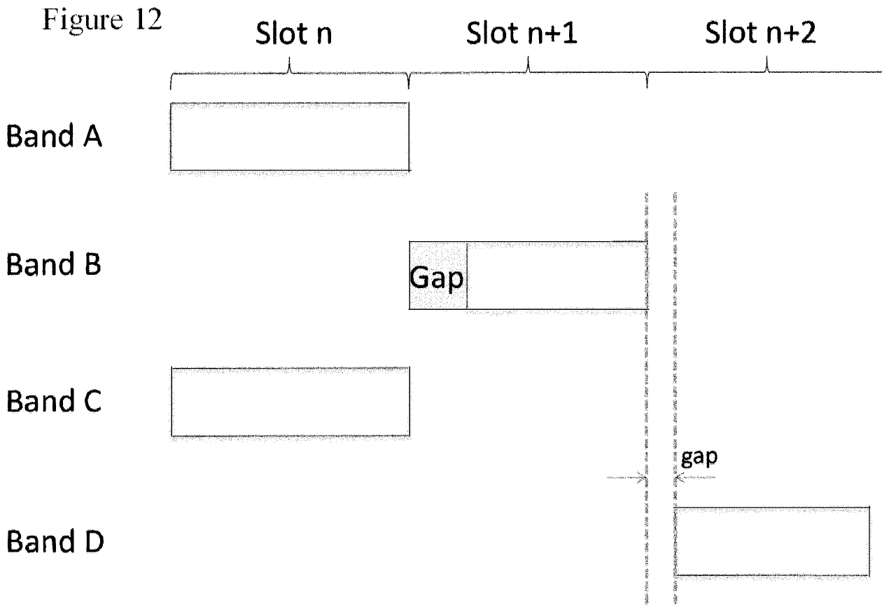

In a second option embodiment, there may be less than the switching gap and the two UL transmissions are within different slots. FIG. 12 shows another example uplink (UL) transmission on four bands with a gap of switching. The two UL transmissions after TX switching may be within the same slot regardless the gap size between the two UL transmissions.

Because UE may not accept more than one UL Tx switching occurring within one slot, there may be a gap between the two UL transmissions after switching that is larger than the switching gap. This may be regarded as one UL TX switching. The gap between two UL transmissions may be less than the switching gap and is only applied for different slots examples.

In a third option embodiment, the two UL transmissions after Tx switching may be within one reference slot. This may be the result of the gap shown in FIG. 12 being extended.

In a fourth option embodiment, based on the latest/earliest T0-Toffset to determine the deadline of the grants for triggering the two UL transmissions which may be within one reference slot. Because the band pair for 1P+1P on band A and C to 1P+1P on band B and D is not clear. It may not be clear whether UE performs Tx switching (from band A to C+B to D) or (from band A to D+B to C).

In some embodiments, with some timeline restriction to apply the one Tx switching of band A+C switching to band B+D, the UE and basestation may have same understanding whether the switching is one Tx switching of band A+C switching to band B+D, or one Tx switching of band A switching to band B and one Tx switching of band C switching to band D. It may be of benefit to avoid useless switching gap with more than one UL Tx switching.

In another embodiment, when two Tx chains are switched between two different band pairs with different lengths of switching periods, neither of the two Tx chains is expected to be used for transmission during the larger one of the two switching periods. In other words, the switching gap may be determined by the larger one of the two switching periods if two band pairs involved for the UL Tx switching.

For a first embodiment, (e.g. 2P on band A switched to 1P on band B+1P on band C): One of the two Tx chains is triggered to switch from one band (named “band A”) to another band (name “band B”), and the other Tx chain is triggered to switch from one band (named “band A”) to another band (name “band C”), the switching gap of case a is determined by max {Tswitch_A-B, Tswitch_A-C}. Note: Tswitch_A-B, Tswitch_A-C are the switching periods reported by the UE for band pair A&B and A&C, respectively.

For a second embodiment (e.g. 1P on band A+1P on band C switched to 1P on band B+1P on band D): regardless whether the UE performs Tx switching {from band A to C and B to D} or {from band A to D and B to C}, neither of the two Tx chains is expected to be used for transmission during the maximum of the four switching periods, i.e., max {Tswitch_A-C, Tswitch_B-D, Tswitch_A-D, Tswitch_B-C}. Note: Tswitch_A-C, Tswitch_B-D, Tswitch_A-D, Tswitch_B-C are the switching periods reported by the UE for band pair A&C, B&D, A&D and B&C, respectively.

For a third embodiment (e.g. 1P on band A+1P on band B switched to 1P on band A+1P on band C): When the UE is to transmit a 1-port+1-port transmission each on one uplink carrier on different bands (1st and 2nd band) and if Tx chain state at the preceding uplink transmission is 1T+1T each on a carrier on one of the bands and another different band (1st or 2nd band, and 3rd band), the switching gap can be determined by one of following options:
Option 1: switching period of band pair B&C, Tswitch_B-C. In other words, one of the two Tx chains is triggered to switch from one band (named “band B”) to another band (name “band C”), and the other Tx chain is unchanged on band A. The switching gap is determined by the switching period of band pair B&C, Tswitch_B-C. In other words, switching gap for Case C can be determined based on switching period of the band pair of the other one of bands and the another different band (2nd or 1st band, and 3rd band).
Option 2: max of {Tswitch_A-C, Tswitch_B-A}. In this example, one of the two Tx chains is triggered to switch from one band (named “band A”) to another band (name “band C”), and the other Tx chain is triggered to switch from the third band (named “band B”) to the one band (name “band A”).
Option 3: max of {Tswitch_A-C, Tswitch_B-A, Tswitch_B-C}. In other words, regardless whether the UE performs Tx switching {from band B to C} or {from band A to C and B to A}, neither of the two Tx chains is expected to be used for transmission during the maximum of the three switching periods, i.e., max {Tswitch_A-C, Tswitch_B-A, Tswitch_B-C}.

Based on this embodiment, when the UE is to transmit a 1-port+1-port transmission each on one uplink carrier on different bands (1st and 2nd band) and if Tx chain state at the preceding uplink transmission is 1T+1T each on a carrier on one of the bands and another different band (1st or 2nd band, and 3rd band), the switching gap for the switching case is clear between the basestation and UE, otherwise UL transmission after UL Tx switching is available from the basestation perspective may be omitted by UE if there is an ambiguous understanding on the switching gap between the basestation and UE.

In another embodiment, with a legacy UL Tx switching, an approach to determine the switching period location may include configuring one band as the switching period located band. The example detailed Rel-16/17 per cell configuration is shown below.

```
ServingCellConfig ::= SEQUENCE {
UplinkConfig ::= SEQUENCE {
uplinkTxSwitching-r16 SetupRelease { UplinkTxSwitching-r16 } OPTIONAL, -- Need M
...
UplinkTxSwitching-r16 ::= SEQUENCE {
  uplinkTxSwitchingPeriodLocation-r16 BOOLEAN,
  uplinkTxSwitchingCarrier-r16 ENUMERATED {carrier1, carrier2}
}
```

In an example of Rel-18 UL Tx switching, that is 3 or 4 bands involved for one uplink switching. The switching period location may be determined by one of following alternatives:
Alt.1: switching period location is configured per band pair. If there are multiple bands configured with switching period location as TRUE in the bands involved in a switching, the switching period location is determined to highest carrier frequency among the bands configured with switching period location as TRUE.
Alt.2: switching period location is configured per band pair, and the priority list of bands is also configured. If there are multiple bands configured with switching period location as TRUE in the bands involved in a switching, the switching period location is determined to the band with lowest priority among bands configured with switching period location as TRUE.
Alt.3: basestation configures “switching-from band” or “switching-to band”. If basestation configures “switching-from band” as switching period location, switching period is located on band(s) where preceding transmission is performed.
Alt.4: The basestation configures switching period location per switching case. In 3 bands case, gNB configures switching period location for each of switching case pair such as {A−B}, {A−C}, {B−C}, {A+B−C}, {A+C−B}, {B+C−A}. In 4 bands case, basestation configures switching period location for each of switching case pair such as {A−B}, {A−C}, {A−D}, {B−C}, {B−D}, {C−D}, {A+B−C}, {A+B−D}, {A+C−B}, {A+C−D}, {A+D−B}, {A+D−C}, {B+C−A}, {B+C−D}, {B+D−A}, {B+D−C}, {C+D−A}, {C+D−B}, {A+B−C+D}, {A+C−B+D}, {A+D−B+C}.
Alt.5: The basestation configures switching period location per configured 3 or 4 bands. In 3 bands case, basestation configures switching period location for each of switching case pair such as {A, B}, {A, C}, {B, C}, {A, B, C}. In 4 bands case, gNB configures switching period location for each of switching case pair such as {A, B}, {A, C}, {A, D}, {B, C}, {B, D}, {C, D}, {A, B, C}, {A, B, D}, {B, C, D}, {A, B, C, D}.
Alt.6: The basestation configures priorities to each carrier/band. The UE determines the switching period location on the band that is not with the highest priority.

In another embodiment for alternative 3, if two bands are involved as the switching-from or switching-to band and also configured with switching period location as TRUE, then the band with configured or lowest/highest band index (or carrier index) is selected, or the band (or carrier) with lowest/highest priority is selected if the priority list of bands (or carriers) is also configured.

In another embodiment for alternative 3, the basestation configures “switching-from band” or “switching-to band” per band combination or each of switching case pair. In this example, any switching case where the switching period should be located. Overall, alternative 3 may include RRC signaling overhead. If the basestation configures “switching-from band” as switching period location, switching period is located on band(s) configured within the band combination where preceding transmission is performed within the band combination.

In another embodiment, when a UE is performed UL Tx switching, the following restrictions may be applied for Rel-18 UL Tx switching across 3 or 4 bands. The UE may not expect to perform more than one uplink switching within a reference slot based on μUL=max(μUL, 1, μUL, 2, μUL, 3) in case of 3 bands, μUL=max(μUL, 1, μUL, 2, μUL, 3, μUL, 4) in case of 4 bands, where μUL, 1, μUL, 2, μUL, 3, μUL, 4 are SCSs of active UL bandwidth parts of the bands in the band combination. If there are two consecutive intra-band carriers in one band, μUL, 1=max(μUL, 1-1, μUL, 1-2), where μUL, 1-1 and μUL, 1-2 are SCSs of active UL bandwidth parts of the carriers in the band.

The UE may not expect to perform two uplink switching within a minimum separation time. The minimum separation time can be determined by one of following options:

Option 1: If two uplink switching are triggered and result in UL transmissions on more than 2 bands within any two consecutive reference slots, then the time duration between the end of all transmission(s) prior to the first uplink switching and the start of all transmission(s) after the second uplink switching within the two reference slots is expected to be not less than a minimum separation time. The minimum separation time is a sum of X us and the switching gap required for the second uplink switching. X us is subject to UE capability with an integer value or value set. Optionally, X can be 0, 50, 100, 200, 500, 1000.

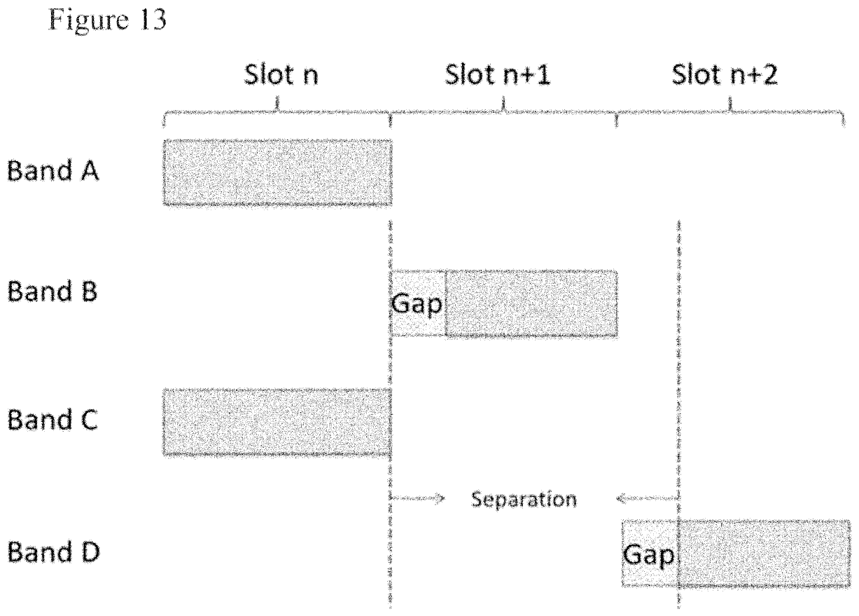

Option 2: If two uplink switching are triggered and result in UL transmissions on more than 2 bands within any two consecutive reference slots, then the time duration between the end of all transmission(s) prior to the first uplink switching and the start of all transmission(s) after the second uplink switching within the two reference slots is expected to be not less than a minimum separation time. The minimum separation time is X us, or a sum of X us and the two switching gaps required for the first uplink switching and the second uplink switching as shown in FIG. 13. X us is subject to UE capability with an integer value or value set. Optionally, X can be 0, 50, 100, 200, 500, 1000.

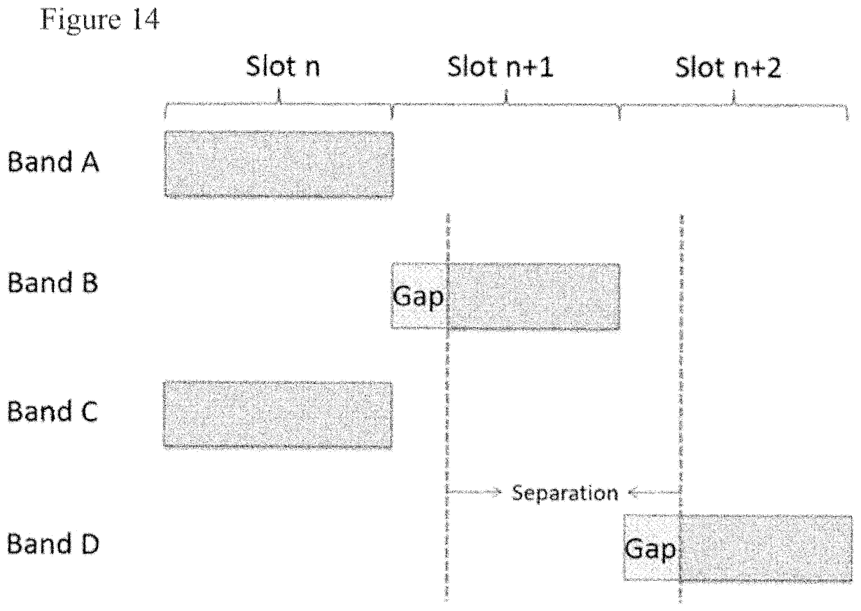

Option 3: If two uplink switching are triggered and result in UL transmissions on more than 2 bands within any two consecutive reference slots, then the time duration between the start of all transmission(s) prior to the second uplink switching and the start of all transmission(s) after the second uplink switching within the two reference slots is expected to be not less than a minimum separation time. The minimum separation time is X us, or a sum of X us and the switching gap required for the second uplink switching as shown in FIG. 14. X us is subject to UE capability with an integer value or value set. Optionally, X can be 0, 50, 100, 200, 500, 1000.

Option 4: If two uplink switching are triggered and result in UL transmissions on more than 2 bands within any two consecutive reference slots, then the time duration between the start of all transmission(s) after to the first uplink switching and the start of all transmission(s) after the second uplink switching within the two reference slots is expected to be not less than a minimum separation time. The minimum separation time is X us, or a sum of X us and the switching gap required for the second uplink switching as shown in FIG. 14. X us is subject to UE capability with an integer value or value set. Optionally, X can be 0, 50, 100, 200, 500, 1000.

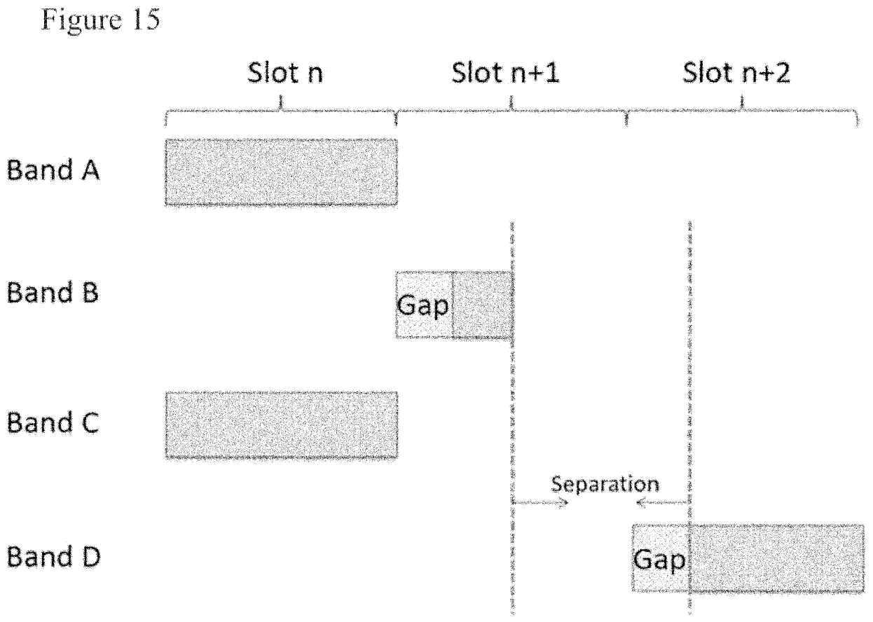

Option 5: If two uplink switching are triggered and result in UL transmissions on more than 2 bands within any two consecutive reference slots, then the time duration between the end of all transmission(s) after to the first uplink switching and the start of all transmission(s) after the second uplink switching within the two reference slots is expected to be not less than a minimum separation time. The minimum separation time is X us, or a sum of X us and the switching gap required for the second uplink switching as shown in FIG. 15. X us is subject to UE capability with an integer value or value set. Optionally, X can be 0, 50, 100, 200, 500, 1000.

Switching for a UE with More than Two Tx

As described above, there may be a limited number of transmitters (Tx). In other embodiments, there may be three or more Tx. For the examples described below, there may be three Tx. For example, The Tx capability considered may be 1Tx in FDD band, and 2Tx UL MIMO/TxD in TDD band. In this example, there may be two example switching scenarios. In a first scenario, 1Tx on TDD switching to FDD (1Tx on FDD+2Tx on TDD band to 2Tx on FDD+1Tx on TDD band). In another example, 1T+2T switched to 2T+1T, that is 1P+2P transmission on band A+B to 2P+1P transmission on band A+B. In a second scenario, there may be 1Tx on FDD switching to TDD (1Tx on FDD+2Tx on TDD band to 0Tx on FDD+3Tx on TDD band). In another example, 1T+2T switched to 0T+3T, that is 1P+2P transmission on band A+B to 0P+3P transmission on band A+B.

In one embodiment, there may be a SUL and CA option in the first scenario.

TABLE 14
SUL and CA Option for the first scenario

| | Number of Tx chains | Number of antenna ports for UL |
|---|---|---|
| | (carrier 1 + carrier 2) | transmission (carrier 1 + carrier 2) |
| Case 1 | 1T + 2T | 0P + 2P [0P + 1P] |
| Case 2 | 2T + 1T | 2P + 0P [1P + 0P] |

There may be one switching example for switched UL: 0P+2P switched to/from 2P+0P. The condition is “when the UE is to transmit a 2-port transmission on one uplink carrier on one band and if the preceding uplink transmission is a 2-port transmission on another uplink carrier on another band, then the UE is not expected to transmit for the duration of N_{Tx1-Tx2} on any of the carriers.”

In another embodiment, there may be a CA second option in the first scenario.

TABLE 15
CA second option in the first scenario

| | Number of Tx chains | Number of antenna ports for UL |
|---|---|---|
| | (carrier 1 + carrier 2) | transmission (carrier 1 + carrier 2) |
| Case 1 | 1T + 2T | [1P + 0P, 1P + 1P, 0P + 1P,] 0P + 2P, 1P + 2P |
| Case 2 | 2T + 1T | [1P + 0P, 1P + 1P, 0P + 1P,] 2P + 0P, 2P + 1P |

Although there may be four switching examples for dual UL: 0P+2P/1P+2P switched to/from 2P+0P/2P+1P, one condition may be sufficient to cover the four examples. When the UE is to transmit a 2-port transmission on one uplink carrier on one band and if the preceding uplink transmission is a 2-port transmission on another uplink carrier on another band, then the UE is not expected to transmit for the duration of N_{Tx1-Tx2} on any of the carriers. There may be no ambiguity for a possible switching scenario 1 of 1Tx on TDD switching to FDD.

In another embodiment, there may be a SUL and CA first option for the second scenario.

TABLE 16
SUL and CA first option for the second scenario

| | Number of Tx chains | Number of antenna ports for UL |
|---|---|---|
| | (carrier 1 + carrier 2) | transmission (carrier 1 + carrier 2) |
| Case 1 | 1T + 2T | 0P + 2P [0P + 1P] |
| Case 2 | 2T + 1T | 2P + 0P [1P + 0P] |
| Case 3 | 0T + 3T | [0P + 3P], 0P + 2P, 0P + 1P |
| Case 4 | 3T + 0T | [3P + 0P], 2P + 0P, 1P + 0P |

Considering 3Tx could be all located on one band, but there is no 3P UL transmission, then 2Tx of the 3Tx could be virtualized as 1Tx and then 2P UL transmission can be used based on 3Tx. P = 1, 2, 4, 8 with Tx ≥ 1, 2, 4, 8.

For a switched UL, in case Tx chains of “1T+2T”, “2T+1T” can be assumed, a switched UL may also include an ambiguity issue. Otherwise, there may be no ambiguity issue for a switched UL. The ambiguity issue may include 3P+0P switching to 0P+2P, Tx chain is 0T+3T or 1T+2T? 3P+0P switching to 0P+1P, Tx chain is 0T+3T, 1T+2T or 2T+1T. For the first ambiguity issue, there may be two states that are enough to resolve the ambiguity issue which is similar as current oneT and twoT. For a second ambiguity issue, there may be three states that are needed to resolve the ambiguity issue, such as oneT, twoT and threeT.

In an example of a switched UL without an ambiguity issue, there may be nine switching examples for switched UL: (0P+3P)/(0P+2P)/(0P+1P) switched to/from (3P+0P)/(2P+0P)/(1P+0P). One condition may be enough to cover the nine example cases. The condition may include when the UE is to transmit a 1-port, 2-port or 3-port transmission on one uplink carrier on one band and if the preceding uplink transmission is a 1-port, 2-port or 3-port transmission on another uplink carrier on another band, then the UE is not expected to transmit for the duration of N_{Tx1-Tx2} on any of the carriers.

In an example case of a switched UL with ambiguity issue, there may be five conditions. The second condition and the third condition can be merged in one embodiment. A first condition may cover (3P+0P)/(2P+0P)/(1P+0P) switched to 0P+3P, which is no ambiguity issue. The condition may include when the UE is to transmit a 3-port transmission on one uplink carrier on one band and if the preceding uplink transmission is a 1-port, 2-port or 3-port transmission on another uplink carrier on another band, then the UE is not expected to transmit for the duration of N_{Tx1-Tx2} on any of the carriers.

A second condition may cover (3P+0P)/(2P+0P)/(1P+0P) within Tx chain of 3T+0T switched to 0P+2P within Tx chain of 0T+3T or 1T+2T, combined with an ambiguity issue. The condition may be combined with ambiguity issue resolution. If the UE is configured with [uplinkTxSwitchingTxState], then set to ‘twoT’ (2T+1T), when the UE is under the operation state in which 3-port transmission can be supported on one carrier on one band followed by no transmission on any carrier on the same band and 2-port transmission on the other carrier on another band the UE shall consider this as if 2-port+1-port transmission was transmitted on both uplinks, otherwise threeT may refer to 3T. The UE shall consider this as if 3-port transmission took place on the transmitting carrier.

A third condition will cover (2P+0P)/(1P+0P) within Tx chain of 2T+1T switched to 0P+2P within Tx chain of 0T+3T or 1T+2T, combined with ambiguity issue. The condition combined with ambiguity issue resolution. If the UE is configured with [uplinkTxSwitchingTxState] set to ‘twoT’ (2T+1T), when the UE is under the operation state in which up to 2-port transmission can be supported on one carrier on one band followed by no transmission on any carrier on the same band and 2-port transmission on the other carrier on another band the UE shall consider this as if 2-port+1-port transmission was transmitted on both uplinks, otherwise ‘threeT’ (3T), the UE shall consider this as if 3-port transmission took place on the transmitting carrier.

A fourth condition may cover (3P+0P)/(2P+0P)/(1P+0P) within Tx chain of 3T+0T switched to 0P+1P within Tx chain of 0T+3T, 1T+2T or 2T+1T, combined with an ambiguity issue. The condition may be combined with ambiguity issue resolution. If the UE is configured with [uplinkTxSwitchingTxState] set to ‘oneT’ (1T+2T), when the UE is under the operation state in which 3-port transmission can be supported on one carrier on one band followed by no transmission on any carrier on the same band and 1-port transmission on the other carrier on another band the UE shall consider this as if 1-port+2-port transmission was transmitted on both uplinks, if the UE is configured with [uplinkTxSwitchingTxState] set to ‘twoT’ (2T+1T), when the UE is under the operation state in which 3-port transmission can be supported on one carrier on one band followed by no transmission on any carrier on the same band and 2-port transmission on the other carrier on another band the UE shall consider this as if 2-port+1-port transmission was transmitted on both uplinks, otherwise ‘threeT’ (3T) the UE shall consider this as if 3-port transmission took place on the transmitting carrier.

A fifth condition may cover (2P+0P)/(1P+0P) within Tx chain of 2T+1T switched to 0P+1P within Tx chain of 0T+3T or 1T+2T, combined with an ambiguity issue. This may be merged to the third condition or may be regarded as invalid.

In another embodiment, there may be a CA second option in the second scenario.

TABLE 17
CA second option in the second scenario

| | Number of Tx chains in | Number of antenna ports for UL transmission |
|---|---|---|
| | WID (carrier 1 + carrier 2) | (carrier 1 + carrier 2) |
| Case 1 | 1T + 2T | 1P + 0P, 1P + 1P, 0P + 1P, 0P + 2P, 1P + 2P |
| Case 2 | 2T + 1T | 1P + 0P, 1P + 1P, 0P + 1P, 2P + 0P, 2P + 1P |
| Case 3 | 0T + 3T | [0P + 3P], 0P + 2P, 0P + 1P |
| Case 4 | 3T + 0T | [3P + 0P], 2P + 0P, 1P + 0P |

There may be an ambiguity issue for: 3P+0P switching to 0P+2P, Tx chain is 0T+3T or 1T+2T? 3P+0P switching to 0P+1P, Tx chain is 0T+3T, 1T+2T or 2T+1T? 3P+0P switching to 1P+1P, Tx chain is 2T+1T or 1T+2T? For the first and second ambiguity issue, it may be similar as switched UL. For the third ambiguity issue, there may be two states to resolve the ambiguity issue which is similar as current oneT and twoT. In an example of dual UL, there may be seven conditions. The first five conditions may be the same as switched UL with additional antenna ports for UL transmission. The sixth and seventh conditions may be only for dual UL.

One condition may cover (3P+0P)/(2P+0P)/(1P+0P)/(2P+1P)/(1P+1P)/(1P+2P) switched to 0P+3P, with no ambiguity issue. The condition is when the UE is to transmit a 3-port transmission on one uplink carrier on one band and if the preceding uplink transmission is a 1-port, 2-port or 3-port transmission on another uplink carrier on another band, then the UE is not expected to transmit for the duration of N_{Tx1-Tx2} on any of the carriers.

A second condition will cover (3P+0P)/(2P+0P)/(1P+0P) within Tx chain of 3T+0T switched to 0P+2P within Tx chain of 0T+3T or 1T+2T, combined with ambiguity issue. The condition combined with ambiguity issue resolution. If the UE is configured with [uplinkTxSwitchingTxState] set to ‘twoT’ (2T+1T), when the UE is under the operation state in which 3-port transmission can be supported on one carrier on one band followed by no transmission on any carrier on the same band and 2-port transmission on the other carrier on another band the UE shall consider this as if 2-port+1-port transmission was transmitted on both uplinks, otherwise ‘threeT’ (3T), the UE may consider this as if 3-port transmission took place on the transmitting carrier.

A third condition may cover (2P+0P)/(1P+0P)/(2P+1P)/(1P+1P)/(0P+1P) within Tx chain of 2T+1T switched to 0P+2P within Tx chain of 0T+3T or 1T+2T, combined with an ambiguity issue. The condition may be combined with ambiguity issue resolution. If the UE is configured with [uplinkTxSwitchingTxState] set to ‘twoT’ (2T+1T), when the UE is under the operation state in which up to 2-port transmission can be supported on one carrier on one band followed by no transmission on any carrier on the same band and 2-port transmission on the other carrier on another band the UE shall consider this as if 2-port+1-port transmission was transmitted on both uplinks. Otherwise, for ‘threeT’ (3T) the UE may consider this as if 3-port transmission took place on the transmitting carrier.

A fourth condition may cover (3P+0P)/(2P+0P)/(1P+0P) within Tx chain of 3T+0T switched to 0P+1P within Tx chain of 0T+3T, 1T+2T or 2T+1T, combined with an ambiguity issue. The condition may be combined with ambiguity issue resolution. If the UE is configured with [uplinkTxSwitchingTxState] set to ‘oneT’ (1T+2T), when the UE is under the operation state in which 3-port transmission can be supported on one carrier on one band followed by no transmission on any carrier on the same band and 1-port transmission on the other carrier on another band the UE shall consider this as if 1-port+2-port transmission was transmitted on both uplinks, if the UE is configured with [uplinkTxSwitchingTxState] set to ‘twoT’ (2T+1T), when the UE is under the operation state in which 3-port transmission can be supported on one carrier on one band followed by no transmission on any carrier on the same band and 2-port transmission on the other carrier on another band the UE shall consider this as if 2-port+1-port transmission was transmitted on both uplinks, otherwise ‘threeT’ (3T) the UE shall consider this as if 3-port transmission took place on the transmitting carrier.

A fifth condition may cover (2P+0P)/(1P+0P)/(2P+1P)/(1P+1P)/(0P+1P) within Tx chain of 2T+1T switched to 0P+1P within Tx chain of 0T+3T or 1T+2T, combined with an ambiguity issue. This may be regarded as invalid for dual UL.

A sixth condition may cover (2P+1P)/(2P+0P)/(3P+0P) switched to 1P+2P, which may have no ambiguity issue. The condition may include when the UE is to transmit a 2-port transmission on one uplink carrier on one band and 1-port transmission on another uplink carrier on another band and if the preceding uplink transmission is a 2-port or 3-port transmission on another uplink carrier on another band, then the UE is not expected to transmit for the duration of N_{Tx1-Tx2} on any of the carriers.

A seventh condition may cover (3P+0P)/(0P+3P) switched to 1P+1P, combined with an ambiguity issue. The condition may be combined with ambiguity issue resolution. If the UE is configured with [uplinkTxSwitchingTxState] set to ‘twoToneT’ (2T+1T), when the UE is under the operation state in which 3-port transmission may be supported on one carrier on one band followed by 1-port transmission on any carrier on the same band and 1-port transmission on the other carrier on another band the UE shall consider this as if 2-port+1-port transmission was transmitted on both uplinks, otherwise ‘oneTtwoT’ (1T+2T), the UE shall consider this as if 1-port+1-port transmission took place on both uplinks.

In the embodiments, 3Tx UE may be assumed, and UL Tx switching with 3Tx on two bands are disclosed. New conditions may be included to perform the UL Tx switching for a 3Tx scenario. New ambiguity issues may be identified and resolved by the embodiments. It may be beneficial to perform UL Tx switching with 3Tx based on the embodiments.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for wireless communication, performed by a wireless communication device, comprising:
receiving a trigger for two uplink (UL) transmission (Tx) chains to switch between two different band pairs; and
performing a first UL switching operation between bands of a first band pair of the two different band pairs and a second UL switching operation between bands of a second band pair of the two different band pairs within two consecutive reference slots,
wherein a time duration between a start of all transmissions after the first UL switching operation and a start of all transmission after the second UL switching operation is greater than a minimum separation time.

2. The method of claim 1, wherein the minimum separation time is based on a capability of the wireless communication device.

3. The method of claim 1, wherein the minimum separation time is equal to a duration X, where X is one of 0 μs, 50 μs, 100 μs, 200 μs, 500 μs, or 1000 μs.

4. The method of claim 3, wherein the minimum separation time is equal to the duration X plus a value of a switching gap for the second UL switching operation.

5. The method of claim 1, wherein a number of bands for the UL transmissions is more than two bands.

6. The method of claim 5, wherein the number of bands is three bands.

7. The method of claim 5, wherein the number of bands is four bands.

8. A method of wireless communication, performed by a wireless communication device, comprising:
receiving a trigger for two uplink (UL) transmission (Tx) chains to switch between two different band pairs; and
identifying a 1-port transmission on one band and a 1-port transmission on another band after the switching as a single Tx switching based on a restriction.

9. The method of claim 8, wherein the restriction comprises the two UL transmissions after the Tx switching is partial overlapped or a gap of the two UL transmissions is less than a threshold value.

10. The method of claim 9, wherein the gap of the two UL transmissions is less than the threshold value and the two UL transmissions are within different slots.

11. The method of claim 9, wherein the threshold value is a switching gap of the UL Tx switching.

12. The method of claim 8, wherein the restriction comprises the two UL transmissions after the Tx switching are within a reference slot.

13. A method of wireless communication, performed by a wireless communication device, comprising:
transmitting up to two uplink (UL) transmissions on a subset of bands from a band combination after a UL transmitter (Tx) switching; and
establishing a condition for the transmitting, wherein 3Tx are supported by the wireless communication device.

14. The method of claim 13, wherein one of the UL transmissions comprises a 1-port, 2-port, or 3-port transmission on one UL carrier on one band of the band combination.

15. The method of claim 14, wherein when the 2-port transmission on a UL carrier is on one band after UL Tx switching and when a preceding UL transmission with a 3Tx state is on another band, then the Tx state after the UL Tx switching is 2Tx or 3Tx on one band by a parameter with two candidate values.

16. The method of claim 14, wherein when the 1-port transmission on a UL carrier on one band after UL Tx switching and when a preceding UL transmission with 3Tx state on another band, then the Tx state after the UL Tx switching is 1Tx, 2Tx or 3Tx on one band by a parameter with three candidate values.

17. A method for wireless communication, performed by a wireless communication node, comprising:
transmitting an indication of triggering for two uplink (UL) transmission (Tx) chains to switch between two different band pairs; and
triggering a first UL switching operation between bands of a first band pair of the two different band pairs and a second UL switching operation between bands of a second band pair of the two different band pairs within two consecutive reference slots,
wherein the triggering is such that a time duration between a start of all transmissions from a wireless communication device after the first UL switching operation and a start of all transmission after the second UL switching operation is greater than a minimum separation time.

18. The method of claim 17, wherein the minimum separation time is based on a capability of the wireless communication device.

19. The method of claim 17, wherein the minimum separation time is equal to a duration X, where X is one of 0 μs, 50 μs, 100 μs, 200 μs, 500 μs, or 1000 μs.

20. The method of claim 1, wherein a number of bands for the UL transmissions is more than two bands.
